(19) United States
(12) Patent Application Publication
(10) Pub. No.: US 2026/0120113 A1
(43) Pub. Date: Apr. 30, 2026

(54) CORRECTIVE AND PREVENTIVE ACTION CONFIGURATION

(71) Applicant: Honeywell International Inc., Charlotte, NC (US)

(72) Inventors: Ankit Singh, Apex, NC (US); Lakshminarayana Paila, Frisco, TX (US); Waad Subber, Schenectady, NY (US); Varun Singh, PUNE (IN); Zillery Fortner, Burlington, KY (US)

(21) Appl. No.: 18/925,104

(22) Filed: Oct. 24, 2024

(51) Int. Cl. G06Q 30/014

(52) U.S. Cl. CPC G06Q 30/014

(57) ABSTRACT

Approaches for automated batch recall assessment are described. The approach includes identifying product batches having a plurality of faulty products manufactured by the organization. For each of the identified product batches, a plurality of quality concerns raised for faulty products manufactured as part of the product batch are quantified. Accordingly, for each product batch, the quantified values of each of the plurality of quality concerns is compared with a corresponding pre-determined threshold count value to enable determination of a quality risk level associated with the product batch. Based on the quality risk level, a batch recall assessment is performed to determine whether to recall product batches having the plurality of faulty products. Thus, the described approaches provide an automated technique for early detection of problematic batches, facilitating quick decision-making on potential batch recalls and improving overall quality management in manufacturing processes.

### BACKGROUND

Corrective and preventive actions are often implemented by organizations to address quality issues and to prevent recurrence of the quality issues identified in relation to products and services offered by the organizations or processes implemented within the organizations. The corrective and preventive actions (CAPAs) may be implemented upon identifying the quality issues during recall decision investigations conducted to examine concerns raised in relation to any products offered by the organization. The concerns may include customer complaints, internal audits, or regulatory inspections. The recall decision investigations may be conducted in an organization to assess whether any set of products or any product batch, distributed by the organization to suppliers or customers, should be recalled considering the concerns raised in relation to the products offered by the organization. Once the quality issues are identified during the recall decision investigations, initiating the CAPAs is essential for the organizations to maintain quality standards, ensure consumer and workforce safety, and comply with regulatory standards.

### BRIEF DESCRIPTION OF FIGURES

Systems and/or methods are now described, in accordance with examples of the present subject matter and with reference to the accompanying figures, in which:

FIG. 1 illustrates a corrective and preventive action (CAPA) configuration system, according to an example;

FIG. 2 illustrates a computing environment implementing the CAPA configuration system, according to another example;

FIG. 3 illustrates a computing environment implementing the CAPA configuration system, according to another example;

FIG. 4 illustrates a schematic diagram depicting an exemplary field-header mapping for configuring a CAPA record corresponding to a recall decision investigation, according to an example;

FIG. 5 illustrates a computing environment implementing a vectorization model to store data required for configuring the CAPA record corresponding to the recall decision investigation, according to an example;

FIGS. 6A to 6E illustrate a method for configuring a CAPA record corresponding to a recall decision investigation, according to an example;

FIG. 7 illustrates a method for attaching relevant documents within the CAPA record configured for the recall decision investigation, according to an example;

FIG. 8 illustrates a method for storing prior investigation data required for configuring a CAPA record corresponding to a recall decision investigation, according to an example;

FIG. 9 illustrates a method for storing CAPA data required for configuring a CAPA record corresponding to a recall decision investigation, according to an example;

FIG. 10 illustrates a method for attaching relevant documents within the CAPA record configured for the recall decision investigation, according to another example; and

FIG. 11 illustrates a computing environment implementing a non-transitory computer-readable medium for configuring a CAPA record corresponding to a recall decision investigation, according to an example.

### DETAILED DESCRIPTION

Typically, for initiating a CAPA to address a particular quality issue, organizations configure a CAPA record in a quality management system utilized by the organizations. The CAPA record serves as a formal documentation of the CAPA to be taken to address quality issues and recurrence of the quality issues in relation to products and services offered by the organizations or processes implemented by the organizations. Users associated with an organization create a new CAPA record in a quality management system utilized by the organization, whenever any correction and preventive action is to be taken by the organization.

Due to lack of a systematic approach for creating a CAPA record, CAPA records created for similar issues may vary significantly across different departments or individuals within an organization. The lack of consistency between the CAPA records may make it difficult for the organization to leverage insights from existing CAPA records when addressing new issues. Inability to effectively refer to existing CAPA records may lead to unnecessary creation of redundant CAPA records for analogous issues. Further, the lack of consistency between the CAPA records may make it difficult for the organization to track trends, implement organization-wide improvements, and ensure regulatory compliance.

In numerous real-world applications, particularly in specialized industrial sectors, users associated with an organization manually configure CAPA records within a quality management system utilized by the organization. The CAPA records may be manually created by the users associated with the organization after every recall decision investigation for which product recall decision has been approved. The CAPA record may have one or more headers. For instance, the one or more headers may include “CAPA title”, “CAPA Type”, “CAPA Source”, “Assessment of risk”, “Actions to be implemented”, “Implementation summary”, “Problem statement”, and “Root cause of the problem”. For creating a CAPA record, a user is required to manually fill-in header data within the one or more headers. For example, under the header “Problem statement”, the user may describe quality issues identified in products or services offered by the organization, or in the processes implemented by the organization. Further, under the header “Root cause of the problem”, the user may describe the root cause of the quality issues. The user is required to manually fill-in the header data for every CAPA record.

Thus, the process of CAPA configuration has been largely manual, relying on human expertise to create, manage, and track the CAPA records. Due to involvement of significant manual efforts for creation of the CAPA records, the process of CAPA configuration is often time-consuming and prone to human error, especially when dealing with large volumes of recall decision investigations. The manual creation of the CAPA records further limits the speed and efficiency with which organizations can respond to quality issues, which may be particularly problematic in time-sensitive situations such as product recalls. As an organization grows and the product lines offered by the organization expand, manually configuring the CAPA records becomes increasingly challenging, leading to backlogs in addressing the quality issues and difficulties in maintaining consistent quality standards across the organization.

Moreover, users typically interact with the quality management system using an electronic device, such as computers, laptops, or tablets, for creating the CAPA records. Manual creation of CAPA records often requires prolonged use of the electronic device which directly translates to increased power consumption, as the electronic device must remain active for longer periods. Further, for creating the CAPA records, users may switch between multiple applications or query databases to gather information to input the header data, leading to consumption of additional computation resources and power. Thus, there is a need for an innovative solution that can automate and streamline the CAPA configuration process, particularly in the context of recall decision investigations.

The present subject matter describes approaches for automatically and efficiently configuring a corrective and preventive action (CAPA) record corresponding to a recall decision investigation conducted in an organization. In an example, the approach involves obtaining investigation reports having investigation data associated with the recall decision investigation. The investigation data may be detailed information, such as analysis results, findings, conclusions, and recommendations, gathered during the recall decision investigation. Rather than directly creating a new CAPA record corresponding to the recall decision investigation, it may be ascertained whether any pre-existing CAPA record associated with the organization is semantically similar to at least a part of the investigation data. In an example, a pre-existing CAPA record may be semantically similar to at least a part of the investigation data when the pre-existing CAPA record relates to a similar issue for which the recall decision investigation is conducted. In another example, a pre-existing CAPA record may be semantically similar to at least a part of the investigation data when the pre-existing CAPA record relates to similar products for which the recall decision investigation is conducted. Upon ascertaining that a pre-existing CAPA record is semantically similar to at least a part of the investigation data, instead of creating a new CAPA record, the pre-existing CAPA record may be updated by incorporating at least a subset of the investigation data to generate an updated CAPA record. The updated CAPA record may then be linked to the recall decision investigation.

Upon ascertaining that no pre-existing CAPA record is semantically similar to at least a part of the investigation data, a new CAPA record may be created by incorporating at least a subset of the investigation data. The new CAPA record may then be linked to the recall decision investigation. The described approach utilizes information already available in the investigation data to autonomously fill-in headers that are relevant for such information within the updated CAPA record or the new CAPA record, without any user input. The described automated approaches are capable of efficiently processing the investigation data to leverage pre-existing CAPA records when possible and create a new CAPA record when necessary, with minimal manual intervention.

In an example, for updating the pre-existing CAPA record, the investigation data and CAPA data corresponding to the pre-existing CAPA record may be analyzed to identify one or more headers, from amongst a plurality of headers within the pre-existing CAPA record, for which semantically relatable data is present within the investigation data. The investigation data may include semantically relatable corresponding subset data for each of the one or more headers. Then, existing header data within each of the one or more headers may be modified to include the corresponding subset data from the investigation data to generate the updated CAPA record.

In an example, for creating a new CAPA record, a pre-defined CAPA format associated with the organization may be obtained. The pre-defined CAPA format may comprise of a set of headers. The investigation data and the set of headers may be analyzed to identify at least one header, from amongst the set of headers, for which semantically relatable data is present within the investigation data. The investigation data may include semantically relatable corresponding subset data for each of the at least one header. Then, header data within each of the at least one header may be updated to include the corresponding subset data from the investigation data to generate the new CAPA record.

In an example, the investigation data may be summarized to generate a summarized investigation report. The summarized investigation report may be attached within the updated CAPA record or the new CAPA record that is linked to the recall decision investigation.

For efficient semantical comparison, all historical investigation reports and historical CAPA records associated with the organization may be stored in vector databases in a vectorized form. In an example, a plurality of investigation reports corresponding to each of a plurality of historical recall decision investigations may be obtained. The plurality of investigation reports may be obtained from an investigation platform utilized by the organization for conducting recall decision investigations. For each historical recall decision investigation of the plurality of historical recall decision investigations, prior investigation data within the plurality of investigation reports corresponding to the historical recall decision investigation may be analyzed to generate vectorized prior investigation data. The vectorized prior investigation data associated with the plurality of historical recall decision investigations may be stored in a first vector database associated with the investigation platform utilized by the organization. Further, CAPA data corresponding to each of a plurality of pre-existing CAPA records may be obtained and analyzed to generate vectorized CAPA data. The CAPA data corresponding to each of the plurality of pre-existing CAPA records may be obtained from a quality management platform utilized by the organization to manage the plurality of pre-existing CAPA records. The vectorized CAPA data associated with the plurality of pre-existing CAPA records may then be stored in a second vector database associated with the quality management platform utilized by the organization.

With respect to the recall decision investigation, the investigation data may be analyzed to generate vectorized investigation data. The first vector database may be queried to identify one or more investigation vectors, from the vectorized prior investigation data within the first vector database, which are similar to the vectorized investigation data. Similar investigation reports, from the plurality of investigation reports of the plurality of historical recall decision investigations, associated with each of the one or more investigation vectors may then be obtained. Further, the second vector database may be queried to identify one or more CAPA vectors, from the vectorized CAPA data within the second vector database, which are similar to the vectorized investigation data. Similar CAPA records, from the pre-existing CAPA records, associated with each of the one or more CAPA vectors may then be obtained. At least one of the similar investigation reports and the similar CAPA records may be attached within the updated CAPA record or the new CAPA record that is linked to the recall decision investigation.

The present subject matter thus, intelligently maps and transfers appropriate subsets of the investigation data to semantically corresponding headers within the CAPA record format or the pre-existing CAPA record, minimizing the need for manual data entry related to CAPA configuration. The capability of the present subject matter to independently identify and populate relevant headers within the CAPA record with relevant data from the investigation data enhances efficiency of CAPA configuration, reduces the potential for transcription errors, and ensures consistent data transfer from investigation reports to the CAPA records.

By automatically updating relevant pre-existing CAPA records based on investigation data of new recall decision investigations, the present subject matter efficiently utilizes existing CAPA records, thereby providing valuable historical context and enabling more informed decision-making and systemic improvements for execution of the CAPA. By utilizing the pre-existing CAPA records, the present subject matter eliminates formation of duplicate CAPA records when a CAPA record already exists in the quality management platform for similar issue, streamlining quality management database of the organization. By implementing automated semantic analysis and attaching similar investigation reports and the similar CAPA records within the new CAPA record or the updated CAPA record, the present subject matter ensures that similar issues are identified and addressed consistently across the organization, reducing variability in CAPA record creation and management. The present subject matter can easily handle a large volume of CAPA configuration, making the technique highly scalable specially as the organization grows.

Due to reduction in manual efforts for configuration of CAPA records, the present subject matter significantly reduces the time and effort required to configure CAPA records. Further, the present subject matter enables a user to configure a CAPA record using the investigation platform itself, eliminating the need for the user to log-in separately to the quality management platform for configuring the CAPA record. By streamlining the CAPA configuration process, the present subject matter enables organizations to respond more quickly to identified quality issues, potentially reducing the adverse impact of the quality issues. Thus, the present subject matter contributes to a more efficient, effective, and proactive approach to quality management, enabling organizations to maintain high standards of product quality and safety while optimizing use of manual or computational resources.

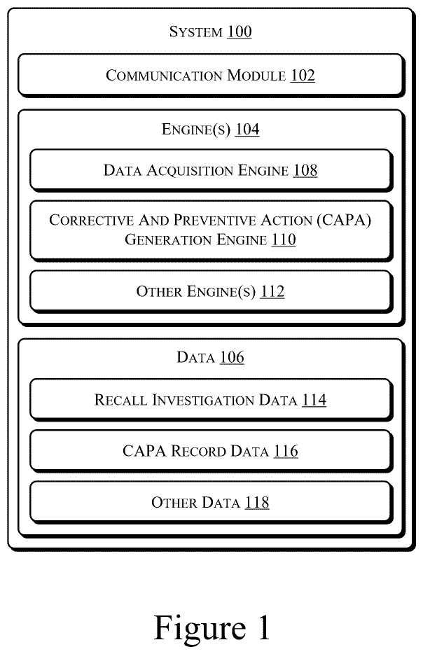

The present subject matter is further described with reference to FIGS. 1 to 11. It should be noted that the description and figures merely illustrate principles of the present subject matter. Various arrangements may be devised that, although not explicitly described or shown herein, encompass the principles of the present subject matter. Moreover, all statements herein reciting principles, aspects, and examples of the present subject matter, as well as specific examples thereof, are intended to encompass equivalents thereof.

FIG. 1 illustrates a corrective and preventive action (CAPA) configuration system 100 for configuring a CAPA record corresponding to a recall decision investigation, according to an example. In one example, the CAPA configuration system 100, hereinafter referred to as the system 100, may be a distributed computing system having one or more physical computing systems geographically distributed at same or different locations. In another example, one or more components of the system 100 may be hosted virtually, for example, on a cloud-based platform, while other components may be geographically distributed at the same or different locations. In yet another example, the system 100 may be a stand-alone physical system geographically located at a particular location. In an example, the system 100 may be utilized by organizations for configuring CAPA records corresponding to recall decision investigations conducted in the organization.

In one example, the system 100 may include a communication module 102, engine(s) 104, and data 106. The system 100 may also include additional components, such as display, input/output interfaces, operating systems, applications, and other software or hardware components (not shown in the figures).

The communication module 102 may be a wireless communication module. Examples of the communication module 102 may include, but are not limited to, Global System for Mobile communication (GSM) modules, Code-division multiple access (CDMA) modules, Bluetooth modules, network interface cards (NIC), Wi-Fi modules, dial-up modules, Integrated Services Digital Network (ISDN) modules, Digital Subscriber Line (DSL) modules, and cable modules. In one example, the communication module 102 may also include one or more antennas to enable wireless transmission and reception of data and signals. The communication module 102 may allow the system 100 to transmit data and signals to one or more other devices; and receive data and signals from the one or more other devices.

The engine(s) 104 may be implemented as a combination of hardware and programming, for example, programmable instructions to implement a variety of functionalities of the engine(s) 104. In examples described herein, such combinations of hardware and programming may be implemented in several different ways. For example, the programming for the engine(s) 104 may be executable instructions. Such instructions may be stored on a non-transitory machine-readable storage medium which may be coupled either directly with the system 100 or indirectly (for example, through networked means). In an example, the engine(s) 104 may include a processing resource, for example, either a single processor or a combination of multiple processors, to execute such instructions. In the present examples, the non-transitory machine-readable storage medium may store instructions that, when executed by the processing resource, implement the engine(s) 104. In other examples, the engine(s) 104 may be implemented as electronic circuitry.

In one example, the engine(s) 104 may include a data acquisition engine 108, a CAPA generation engine 110, and other engine(s) 112. The other engine(s) 112 may further implement functionalities that supplement functions performed by the system 100 or any of the engine(s) 104.

The data 106 includes data that is either received, stored, or generated as a result of functions implemented by any of the engine(s) 104 or the system 100. It may be further noted that information stored and available in the data 106 may be utilized by the engine(s) 104 for performing various functions of the system 100. The data 106 may include recall investigation data 114, CAPA record data 116, and other data 118. The recall investigation data 114 may include information gathered or analyzed during recall decision investigations conducted in an organization. The information gathered or analyzed during the recall decision investigations may include investigation reports generated based on the recall decision investigations. The CAPA record data 116 may include CAPA records configured by the system 100 and pre-existing CAPA records obtained from an external platform, such as a quality management platform, utilized by the organization to manage a plurality of pre-existing CAPA records associated with the organization. The other data 118 may include data that is either received, stored, or generated as a result of functions implemented by any of the engine(s) 104.

In operation, the communication module 102 may receive a CAPA configuration request corresponding to a recall decision investigation conducted in an organization. The CAPA configuration request may be initiated by a user associated with the organization. In an example, the user may use any electronic device, such as a laptop or a mobile device, to trigger CAPA configuration in relation to the recall decision investigation. For example, the system 100 may provide a user interface, such as a graphical user interface (GUI) or an application programming interface (API), accessible through the electronic device for submitting the CAPA configuration request.

The data acquisition engine 108 may obtain one or more investigation reports having investigation data associated with the recall decision investigation. The one or more investigation reports may be interchangeably referred to as the investigation reports. The investigation data may be detailed information, such as analysis results, findings, conclusions, and recommendations, gathered during the recall decision investigation. Thus, the investigation reports may serve as comprehensive records of the recall decision investigation. In an example, the investigation reports may be obtained from an investigation platform utilized by the organization for conducting the recall decision investigation. In another example, the investigation reports may be pre-stored in a memory of the system 100 and may be obtained from the memory. In one example, the one or more investigation reports may be stored as the recall investigation data 114.

Once the investigation reports are obtained, the CAPA generation engine 110 may obtain CAPA data corresponding to each of a plurality of pre-existing CAPA records associated with the organization. In an example, the CAPA data corresponding to a pre-existing CAPA record may include information contained within the pre-existing CAPA record. The information contained within the pre-existing CAPA record may include a plurality of headers within the pre-existing CAPA record and existing header data present within each of the plurality of headers. Each of the plurality of headers may represent a particular aspect of the pre-existing CAPA record and the corresponding existing header data may be information regarding the particular aspect. In an example, the CAPA data corresponding to each of the plurality of pre-existing CAPA records may be obtained from the quality management platform. In another example, the CAPA data may be pre-stored in a memory of the system 100 and may be obtained from the memory. In one example, the CAPA data may be stored as the CAPA record data 116.

The CAPA generation engine 110 may then analyze the investigation data and the CAPA data corresponding to each of the plurality of pre-existing CAPA records to identify a pre-existing CAPA record, from amongst the plurality of pre-existing CAPA records, that is semantically similar to at least a part of the investigation data. In an example, the investigation data and the CAPA data may be analyzed using a large language model (LLM) to identify the pre-existing CAPA record that is semantically similar to at least a part of the investigation data. In another example, the investigation data and the CAPA data may be stored in a vectorized form in one or more vector databases. Vectors corresponding to the investigation data may be compared with vectors corresponding to the CAPA data to identify the pre-existing CAPA record that is semantically similar to at least a part of the investigation data. In an example, for identifying the pre-existing CAPA record that is semantically similar to at least a part of the investigation data, semantic comparisons may be performed either through the LLM or using the vectors. Further, synonym mappings, received from a user of the organization, may also be utilized while performing the semantic comparison through the LLM or using the vectors. The synonym mappings may augment semantic understanding capabilities of both the LLM-based and vector-based approaches. The synonym mappings may provide synonymous terminologies specifically in the context of the organization, enabling the CAPA generation engine 110 to more accurately identify semantically similar pre-existing CAPA records.

The CAPA generation engine 110 may analyze the investigation data and CAPA data corresponding to the pre-existing CAPA record to identify one or more headers within the pre-existing CAPA record for which semantically relatable data is present within the investigation data. The investigation data may include semantically relatable corresponding subset data for each of the one or more headers. In an example, the CAPA generation engine 110 may utilize natural language processing techniques for effectively identifying the one or more headers and the semantically relatable corresponding subset data for each of the one or more headers.

For example, assuming the investigation data “During routine quality control checks, it was discovered that batch XYZ123 of our pain relief medication showed inconsistent active ingredient concentrations. Analysis revealed that the mixing process was not maintaining uniform temperature, leading to uneven distribution of the active ingredient. To address this, we will recalibrate the mixing equipment and implement a new monitoring system for temperature control. Additionally, we will increase the frequency of in-process checks during mixing. These actions will be completed within 30 days, and we will conduct a follow-up analysis after 60 days to ensure effectiveness.”, the CAPA generation engine 110 may identify a first header “problem statement” within the pre-existing CAPA record for which semantically relatable corresponding subset data “batch XYZ123 of our pain relief medication showed inconsistent active ingredient concentrations” is present within the investigation data. Further, the CAPA generation engine 110 may identify a second header “root cause of problem” within the pre-existing CAPA record for which semantically relatable corresponding subset data “mixing process was not maintaining uniform temperature, leading to uneven distribution of the active ingredient” is present within the investigation data. Further, the CAPA generation engine 110 may identify a third header “action to be implemented” within the pre-existing CAPA record for which semantically relatable corresponding subset data “recalibrate the mixing equipment and implement a new monitoring system for temperature control” and “increase the frequency of in-process checks during mixing” is present within the investigation data. Thus, the CAPA generation engine 110 may map each of the one or more headers with the semantically relatable corresponding subset data that is conceptually similar or relevant to the corresponding header, even if the exact wordings differ between the corresponding CAPA data and the investigation data.

Once the one or more headers are identified, the CAPA generation engine 110 may modify existing header data within each of the one or more headers to include the corresponding subset data from the investigation data to generate an updated CAPA record. In an example, the corresponding subset data may be included in the existing header data through various methods, such as intelligent integration, chronological appending, hierarchical structuring, differential highlighting, and semantic merging, to ensure coherent, non-redundant, and contextually appropriate inclusion of the corresponding subset data with the existing header data.

The CAPA generation engine 110 may link the updated CAPA record to the recall decision investigation. In an example, linking the updated CAPA record to the recall decision investigation may include transmitting the updated CAPA record to the quality management platform for updating CAPA records managed by the quality management platform. Thus, the present subject matter eliminates the need for the user to log-in separately to the quality management platform for configuring the CAPA record. Further, the present subject matter utilizes information already available in the investigation data to autonomously fill-in the one or more headers that are relevant for such information within the updated CAPA record, without any user input.

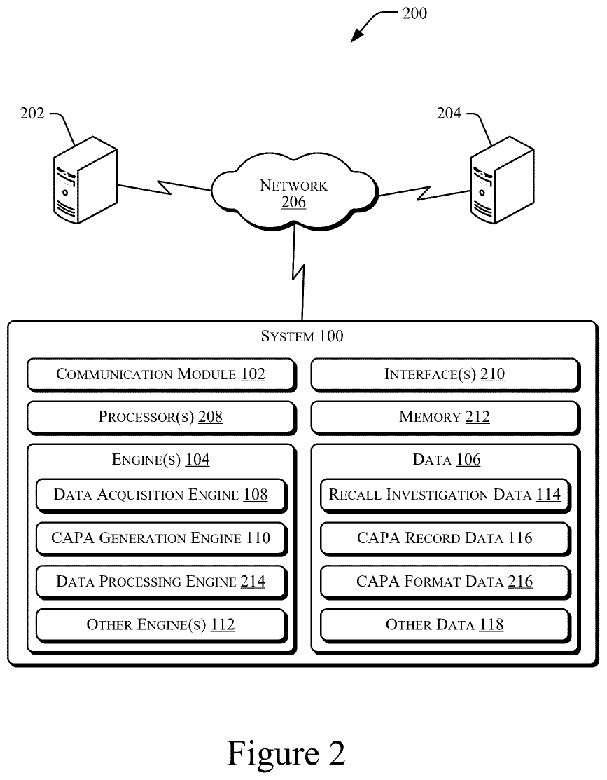

FIG. 2 illustrates a computing environment 200 implementing the CAPA configuration system 100 for configuring a CAPA record corresponding to a recall decision investigation, according to an example. In an example, the recall decision investigation may have been conducted by an organization to assess whether any set of products or any product batch, distributed by the organization to suppliers or customers, should be recalled considering concerns raised in relation to products and services offered by the organization or processes implemented within the organizations. The concerns may include customer complaints, internal audits, or regulatory inspections.

In one example, the computing environment 200 may include the system 100, a recall investigation server 202, and a quality management server 204. In an example, the recall investigation server 202 may be a distributed computing system having one or more physical computing systems geographically distributed at same or different locations. In another example, one or more components of the recall investigation server 202 may be hosted virtually, for example, on a cloud-based platform, while other components may be geographically distributed at the same or different locations. In yet another example, the recall investigation server 202 may be a stand-alone physical system geographically located at a particular location. In an example, the recall investigation server 202 may be configured to facilitate and manage the process of recall decision investigations associated with the organization. The recall investigation server 202 may offer an investigation platform, such a software-application, that can be accessed by users of the organization for conducting, documenting, and tracking the recall decision investigations. Thus, the recall investigation server 202 may store investigation data related to the recall decision investigations conducted in the organization.

In an example, the quality management server 204 may be a distributed computing system having one or more physical computing systems geographically distributed at same or different locations. In another example, one or more components of the quality management server 204 may be hosted virtually, for example, on a cloud-based platform, while other components may be geographically distributed at the same or different locations. In yet another example, the quality management server 204 may be a stand-alone physical system geographically located at a particular location. In an example, the quality management server 204 may be configured to centralize and manage quality-related processes, data, and documentation associated with the organization, such as CAPA records of corrective and preventive actions (CAPA) executed or to be executed by the organization. The quality management server 204 may offer a quality management platform, such a software-application, that can be accessed by the users of the organization for accessing, documenting, and tracking CAPA records associated with the organization. Thus, the quality management server 204 may store CAPA data corresponding to each of the CAPA records.

The system 100, the recall investigation server 202, and the quality management server 204 may be communicably coupled with each other over a communication network 206 and may exchange data and signals over the communication network 206. The communication network 206 may be a wireless network, a wired network, or a combination thereof. The communication network 206 may also be an individual network or a collection of many such individual networks, interconnected with each other and functioning as a single large network, e.g., the Internet or an intranet. Examples of such individual networks include local area network (LAN), wide area network (WAN), the internet, Global System for Mobile Communication (GSM) network, Universal Mobile Telecommunications System (UMTS) network, Personal Communications Service (PCS) network, Time Division Multiple Access (TDMA) network, Code Division Multiple Access (CDMA) network, Next Generation Network (NGN), Public Switched Telephone Network (PSTN), and Integrated Services Digital Network (ISDN).

Depending on the technology, the communication network 206 may include various network entities, such as transceivers, gateways, and routers. In an example, the communication network 206 may include any communication network that uses any of the commonly used protocols, for example, Hypertext Transfer Protocol (HTTP), and Transmission Control Protocol/Internet Protocol (TCP/IP).

In one example, the system 100 may include the communication module 102, processor(s) 208, interface(s) 210, memory 212, the engine(s) 104, and the data 106. The system 100 may also include other components, such as display, input/output interfaces, operating systems, applications, and other software or hardware components (not shown in the figures).

The communication module 102 may allow the system 100 to transmit data and signals to one or more other devices, such as the recall investigation server 202 and the quality management server 204; and receive data and signals from the one or more other devices. The processor(s) 208 may be implemented as microprocessors, microcomputers, microcontrollers, digital signal processors, central processing units, state machines, logic circuitries, and/or other devices that manipulate signals based on operational instructions. The interface(s) 210 may allow the connection or coupling of the system 100 with one or more other devices, such as the recall investigation server 202 and the quality management server 204, through a wired (e.g., Local Area Network, i.e., LAN) connection or through a wireless connection (e.g., Bluetooth®, Wi-Fi). The interface(s) 210 may also enable intercommunication between different logical as well as hardware components of the system 100.

The memory 212 may be a computer-readable medium, examples of which include volatile memory (e.g., RAM), and/or non-volatile memory (e.g., Erasable Programmable read-only memory, i.e., EPROM, flash memory, etc.). The memory 212 may be an external memory or an internal memory, such as a flash drive, a compact disk drive, an external hard disk drive, or the like. The memory 212 may further include the data 106 and/or other data which may either be received, utilized, or generated during the operation of the system 100.

The engine(s) 104 may include the data acquisition engine 108, the CAPA generation engine 110, and the other engine(s) 112, as explained with reference to FIG. 1. In an example, the engine(s) 104 may further include a data processing engine 214.

The data 106 may include the recall investigation data 114, the CAPA record data 116, and the other data 118, as explained with reference to FIG. 1. In an example, the data 106 may further include CAPA format data 216. In an example, the CAPA format data 216 may include one or more pre-defined CAPA formats, such as standardized CAPA templates, customarily used by the organization for documenting CAPA records associated with the organization.

In operation, the system 100 may be utilized for CAPA configuration when a CAPA configuration request is triggered by a user of the organization. In an example, the communication module 102 may receive the CAPA configuration request corresponding to a recall decision investigation conducted in the organization. The CAPA configuration request may be initiated by the user through any electronic device, such as a laptop or a mobile device. For example, the system 100 may provide a user interface, such as a graphical user interface (GUI) or an application programming interface (API), accessible through the electronic device for submitting the CAPA configuration request. In an example, the system 100, for configuring CAPA records associated with the organization, may be implemented through the investigation platform, such as a specialized software-application, managed through the recall investigation server 202. Thus, the investigation platform may be augmented with CAPA configuration capabilities, enabling seamless management of corrective and preventive actions arising from recall decision investigations conducted in the organization.

The data acquisition engine 108 may obtain one or more investigation reports having investigation data associated with the recall decision investigation. The one or more investigation reports may be interchangeably referred to as the investigation reports. The investigation data may be detailed information, such as analysis results, findings, conclusions, and recommendations, gathered during the recall decision investigation. Thus, the investigation reports may serve as comprehensive records of the recall decision investigation. In an example, the investigation reports may be obtained from the recall investigation server 202. In another example, the investigation reports may be pre-stored in the memory 212 of the system 100 and may be obtained from the memory 212. In one example, the one or more investigation reports may be stored as the recall investigation data 114.

In an example, the investigation data may comprise a plurality of fields and field data corresponding to each of the plurality of fields. Each of the plurality of fields may represent a specific aspect of the recall decision investigation, and the corresponding field data may provide relevant information gathered during the recall decision investigation regarding the specific aspect. For example, a first field in the investigation data may be “root cause” and the corresponding field data may be “analysis revealed that the mixing process was not maintaining uniform temperature, leading to uneven distribution of the active ingredient”, describing the root cause of a concern which is investigated through the recall decision investigation. Further, a second field in the investigation data may be “plan” and the corresponding field data may be “to address the problem, we will recalibrate the mixing equipment and implement a new monitoring system for temperature control. Additionally, we will increase the frequency of in-process checks during mixing”, describing the corrective and preventive action that may address the concern is investigated through the recall decision investigation.

Once the investigation reports are obtained, the CAPA generation engine 110 may obtain CAPA data corresponding to each of a plurality of pre-existing CAPA records associated with the organization. In an example, the CAPA data corresponding to a pre-existing CAPA record may include information contained within the pre-existing CAPA record. In an example, the CAPA data corresponding to each of the plurality of pre-existing CAPA records may be obtained from the quality management server 204. In another example, the CAPA data may be pre-stored in the memory 212 of the system 100 and may be obtained from the memory 212. In one example, the CAPA data may be stored as the CAPA record data 116.

In an example, the CAPA data of each pre-existing CAPA record of the plurality of pre-existing CAPA records may comprise a plurality of headers within the pre-existing CAPA record and existing header data present within each of the plurality of headers. Each of the plurality of headers may represent a particular aspect of the pre-existing CAPA record. In an example, the corresponding existing header data may be blank, awaiting input. In another example, the corresponding existing header data may pre-populated with pertinent information regarding the particular aspect. For example, a first header in the pre-existing CAPA record may be “preventive action implemented” and the corresponding existing header data may be blank as no prevention action may have been formulated or implemented when the pre-existing CAPA record was last created, modified, or stored in the quality management server 204. Further, a second header in the pre-existing CAPA record may be “problem statement” and the corresponding existing header data may be pre-populated as “batch XYZ123 of our pain relief medication showed inconsistent active ingredient concentrations”.

The CAPA generation engine 110 may analyze the investigation data and the CAPA data corresponding to each of the plurality of pre-existing CAPA records to ascertain whether any pre-existing CAPA record, from amongst the plurality of pre-existing CAPA records, is semantically similar to at least a part of the investigation data. In an example, the investigation data and the CAPA data may be analyzed using a large language model (LLM) to ascertain whether any pre-existing CAPA record is semantically similar to at least a part of the investigation data. In another example, the investigation data and the CAPA data may be stored in a vectorized form in one or more vector databases. Vectors corresponding to the investigation data may be compared with vectors corresponding to the CAPA data to ascertain whether any pre-existing CAPA record is semantically similar to at least a part of the investigation data. In an example, for ascertaining whether any pre-existing CAPA record is semantically similar to at least a part of the investigation data, semantic comparisons may be performed either through the LLM or using the vectors. Further, synonym mappings, received from a user of the organization, may also be utilized while performing the semantic comparison through the LLM or using the vectors. The synonym mappings may augment semantic understanding capabilities of both the LLM-based and vector-based approaches. The synonym mappings may provide synonymous terminologies specifically in the context of the organization, enabling the CAPA generation engine 110 to more accurately identify semantically similar pre-existing CAPA records.

In an example, a pre-existing CAPA record may be identified to be semantically similar to at least a part of the investigation data when the investigation data and the CAPA data pertain to similar products of the organization, similar quality concern affecting the organization, and similar corrective and preventive actions. In another example, the pre-existing CAPA record and the investigation data may be associated with the same recall decision investigation, such as when the pre-existing CAPA record was prematurely created before the recall decision investigation was fully concluded, or when additional findings or conclusions emerge related to the recall decision investigation subsequent to the creation and storage of the pre-existing CAPA record.

Upon ascertaining a pre-existing CAPA record, from the plurality of pre-existing CAPA records, to be semantically similar to at least a part of the investigation data, the CAPA generation engine 110 may update the pre-existing CAPA record to generate an updated CAPA record, instead of creating a new CAPA record. The pre-existing CAPA record may be updated by incorporating at least a subset of the investigation data. Thus, instead of creating an entirely new CAPA record, the CAPA generation engine 110 may identify relevant information, i.e., the subset of the investigation data, from the investigation data, and incorporate the relevant information into the pre-existing CAPA record, thereby combining pre-populated information within the pre-existing CAPA record with new findings from the investigation data.

In an example, for updating the pre-existing CAPA record, the CAPA generation engine 110 may analyze the investigation data and CAPA data corresponding to the pre-existing CAPA record to identify one or more headers, from amongst the plurality of headers, within the pre-existing CAPA record for which semantically relatable data is present within the investigation data. The investigation data may include semantically relatable corresponding subset data for each of the one or more headers. In an example, the CAPA generation engine 110 may utilize natural language processing techniques for effectively identifying the one or more headers and the semantically relatable corresponding subset data for each of the one or more headers.

For analyzing the investigation data and the CAPA data corresponding to the pre-existing CAPA record, the CAPA generation engine 110 may semantically compare the plurality of fields with the plurality of headers corresponding to the pre-existing CAPA record to identify semantically similar fields and headers. For example, a first field “summary” within the investigation data may be identified to be semantically similar to a first header “CAPA implementation summary” within the pre-existing CAPA record. Further, a second field “objective” within the investigation data may be identified to be semantically similar to a second header “explanation of problem” within the pre-existing CAPA record. Further, a third field “root cause type” and a fourth field “root cause” within the investigation data may be identified to be semantically similar to a third header “root cause of problem” within the pre-existing CAPA record. Each header identified to have at least one semantically similar field in the investigation data may be designated as the one or more headers for which semantically relatable data is present within the investigation data.

Further, the CAPA generation engine 110 may modify existing header data within each of the one or more headers to include the corresponding subset data from the investigation data to generate the updated CAPA record. In an example, the corresponding subset data may be included in the existing header data through various data merging techniques, such as intelligent integration, chronological appending, hierarchical structuring, differential highlighting, and semantic merging, to ensure coherent, non-redundant, and contextually appropriate inclusion of the corresponding subset data with the existing header data. In an example, if the corresponding existing header data within a header of the one or more headers is pre-populated with some information, the CAPA generation engine 110 may automatically modify the corresponding existing header data using the data merging techniques, without any user input. In another example, if the existing header data within the header of the one or more headers is pre-populated with some information, the CAPA generation engine 110 may prompt a user to indicate a particular merging option from a plurality of merging options and modify the corresponding existing header data in accordance with the particular merging option indicated by the user. For instance, the user may choose to simply append the corresponding subset data without changing pre-populated information within the existing header data. In another instance, the user may choose to replace the pre-populated information within the existing header data with the corresponding subset data.

For modifying the existing header data within each of the one or more headers, the CAPA generation engine 110 may modify the existing header data within each header of the one or more headers having a single semantically similar field in the investigation data to include the field data corresponding to the semantically similar field to generate the updated CAPA record. For example, first field data corresponding to the first field “summary” may be incorporated in the corresponding existing header data within the first header “CAPA implementation summary”. Further, second field data corresponding to the second field “objective” may be incorporated in the corresponding existing header data within the second header “explanation of problem”.

Further, for each header of the one or more headers having two or more semantically similar fields in the investigation data, the CAPA generation engine 110 may generate an interactive query dialog to seek a user input for selecting fields from the two or more semantically similar fields and prioritizing the selected fields. For example, the user may select one or both of the third field “root cause type” and the fourth field “root cause” for modifying the existing header data. If the user selects both the third field “root cause type” and the fourth field “root cause”, the user may also prioritize the selected fields by providing a hierarchical arrangement of the third field and the fourth field. The CAPA generation engine 110 may receive a user input specifying the hierarchical arrangement of selected fields from the two or more semantically similar fields. The CAPA generation engine 110 may modify the existing header data within the header to include the field data corresponding to the selected fields in accordance with the hierarchical arrangement to generate the updated CAPA record. The updated CAPA record may thus be a version of the pre-existing CAPA record once each of the one or more headers are modified using the investigation data.

The CAPA generation engine 110 may link the updated CAPA record to the recall decision investigation. In an example, linking the updated CAPA record to the recall decision investigation may include transmitting the updated CAPA record to the quality management platform for updating CAPA records managed by the quality management platform. Thus, the present subject matter eliminates the need for the user to log-in separately to the quality management platform for configuring the CAPA record. Further, the present subject matter utilizes information already available in the investigation data to autonomously fill-in the one or more headers that are relevant for such information within the updated CAPA record, without any user input.

Upon ascertaining that no pre-existing CAPA record is semantically similar to at least a part of the investigation data, the CAPA generation engine 110 may create a new CAPA record by incorporating at least a subset of the investigation data. In an example, for creating a new CAPA record, the CAPA generation engine 110 may obtain a pre-defined CAPA format associated with the organization. The pre-defined CAPA format may be defined as standardized CAPA templates customarily used by the organization for documenting CAPA records associated with the organization. The pre-defined CAPA format may comprise of a set of headers. For example, the pre-defined CAPA format may comprise of a first header “title”, a second header “product”, a third header “CAPA source”, a fourth header “CAPA implementation summary”, a fifth header “root cause of problem”, a sixth header “explanation of problem”, and a seventh header “action to be completed”. In an example, the pre-defined CAPA format may be obtained from a user associated with the organization. In another example, the pre-defined CAPA format may be pre-stored in the memory 212 of the system 100 and may be obtained from the memory 212. In one example, the pre-defined CAPA format may be stored as the CAPA format data 216.

The CAPA generation engine 110 may analyze the investigation data and the set of headers to identify at least one header, from amongst the set of headers, for which semantically relatable data is present within the investigation data. The investigation data may include semantically relatable corresponding subset data for each of the at least one header. In an example, the CAPA generation engine 110 may utilize natural language processing techniques for effectively identifying the at least one headers and the semantically relatable corresponding subset data for each of the at least one header.

For analyzing the investigation data and the set of headers, the CAPA generation engine 110 may semantically compare the plurality of fields with the set of headers to identify semantically similar fields and headers. For example, the first field “summary” within the investigation data may be identified to be semantically similar to the fourth header “CAPA implementation summary” within the pre-defined CAPA format. Further, the second field “objective” within the investigation data may be identified to be semantically similar to the sixth header “explanation of problem” within the pre-defined CAPA format. Further, a third field “root cause type” and a fourth field “root cause” within the investigation data may be identified to be semantically similar to the fourth header “root cause of problem” within the pre-defined CAPA format. Each header identified to have at least one semantically similar field in the investigation data is designated as the at least one header for which semantically relatable data is present within the investigation data.

Further, the CAPA generation engine 110 may update header data within each of the at least one header to include the corresponding subset data from the investigation data to generate the new CAPA record. For updating the header data within each of the at least one header, the CAPA generation engine 110 may update the header data, within each header of the at least one header having one semantically similar field in the investigation data, to include the field data corresponding to the semantically similar field to generate the new CAPA record. For example, the first field data corresponding to the first field “summary” may be incorporated in the corresponding header data within the first header “CAPA implementation summary”. Further, the second field data corresponding to the second field “objective” may be incorporated in the corresponding header data within the second header “explanation of problem”.

Further, for each header of the at least one header having two or more semantically similar fields in the investigation data, the CAPA generation engine 110 may generate an interactive query dialog to seek a user input for selecting fields from the two or more semantically similar fields and prioritizing the selected fields. For example, the user may select one or both of the third field “root cause type” and the fourth field “root cause” for modifying the corresponding header data. If the user selects both the third field “root cause type” and the fourth field “root cause”, the user may also prioritize the selected fields by providing a hierarchical arrangement of the third field and the fourth field. The CAPA generation engine 110 may receive a user input specifying a hierarchical arrangement of selected fields from the two or more semantically similar fields. The CAPA generation engine 110 may update the header data within the header to include the field data corresponding to the selected fields in accordance with the hierarchical arrangement to generate the new CAPA record. The new CAPA record may thus be a version of the pre-defined CAPA format once each of the at least one header is updated using the investigation data.

The CAPA generation engine 110 may link the new CAPA record to the recall decision investigation. In an example, linking the new CAPA record to the recall decision investigation may include transmitting the new CAPA record to the quality management platform for updating CAPA records managed by the quality management platform. Thus, the present subject matter eliminates the need for the user to log-in separately to the quality management platform for configuring the CAPA record. Further, the present subject matter utilizes information already available in the investigation data to autonomously fill-in the at least one header that are relevant for such information within the new CAPA record, without any user input.

In an example, the CAPA generation engine 110 may summarize the investigation data to generate a summarized investigation report. Further, the CAPA generation engine 110 may attach the summarized investigation report within the updated CAPA record or the new CAPA record that is linked to the recall decision investigation. In an example, the summarized investigation report may be attached in different file formats, such as a portable document format (PDF) or an editable format. In an example, the summarized investigation report may be attached in a default file format, unless the user specifically provides inputs regarding the desired file format. In an example, the summarized investigation report may capture key findings, conclusions, and recommendations from the full investigation data.

For efficient semantical comparison, all historical investigation reports and historical CAPA records associated with the organization may be stored in vector databases in a vectorized form. In an example, the data processing engine 214 may obtain a plurality of investigation reports corresponding to each of a plurality of historical recall decision investigations conducted in the organization. In an example, the plurality of investigation reports may be obtained from the recall investigation server 202. In another example, the plurality of investigation reports may be pre-stored in the memory 212 of the system 100 and may be obtained from the memory 212. In one example, the plurality of investigation reports may be stored as the recall investigation data 114.

For each historical recall decision investigation of the plurality of historical recall decision investigations, the data processing engine 214 may analyze prior investigation data within the plurality of investigation reports corresponding to the historical recall decision investigation to generate vectorized prior investigation data. The data processing engine 214 may then store the vectorized prior investigation data associated with the plurality of historical recall decision investigations in a first vector database associated with the investigation platform utilized by the organization for conducting recall decision investigations. Storing the vectorized prior investigation data in the first vector database allows the organization to maintain a searchable history of the plurality of historical recall decision investigations.

Further, the data processing engine 214 may analyze the CAPA data corresponding to each of the plurality of pre-existing CAPA records to generate vectorized CAPA data. The data processing engine 214 may then store the vectorized CAPA data associated with the plurality of pre-existing CAPA records in a second vector database associated with the quality management platform utilized by the organization. Storing the vectorized CAPA data in the second vector database allows the organization to maintain a searchable history of the plurality of pre-existing CAPA records. In an example, the data processing engine 214 may utilize a same vectorization model for generating the vectorized prior investigation data and the vectorized CAPA data.

With respect to the recall decision investigation for which the CAPA configuration request is received, the CAPA generation engine 110 may analyze the investigation data to generate vectorized investigation data. Then, the CAPA generation engine 110 may query the first vector database to identify one or more investigation vectors, from the vectorized prior investigation data within the first vector database, which are similar to the vectorized investigation data. The CAPA generation engine 110 may then obtain similar investigation reports, from the plurality of investigation reports of the plurality of historical recall decision investigations, associated with each of the one or more investigation vectors.

Further, the CAPA generation engine 110 may query the second vector database to identify one or more CAPA vectors, from the vectorized CAPA data within the second vector database, which are similar to the vectorized investigation data. The CAPA generation engine 110 may then obtain similar CAPA records, from the pre-existing CAPA records, associated with each of the one or more CAPA vectors. The CAPA generation engine 110 may then attach at least one of the similar investigation reports and the similar CAPA records within the updated CAPA record or the new CAPA record that is linked to the recall decision investigation. By implementing automated semantic analysis and attaching similar investigation reports and the similar CAPA records within the new CAPA record or the updated CAPA record, the present subject matter ensures that similar issues are identified and addressed consistently across the organization, reducing variability in CAPA record creation and management. Thus, the present subject matter contributes to a more efficient, effective, and proactive approach to quality management, enabling organizations to maintain high standards of product quality and safety while optimizing use of manual or computational resources.

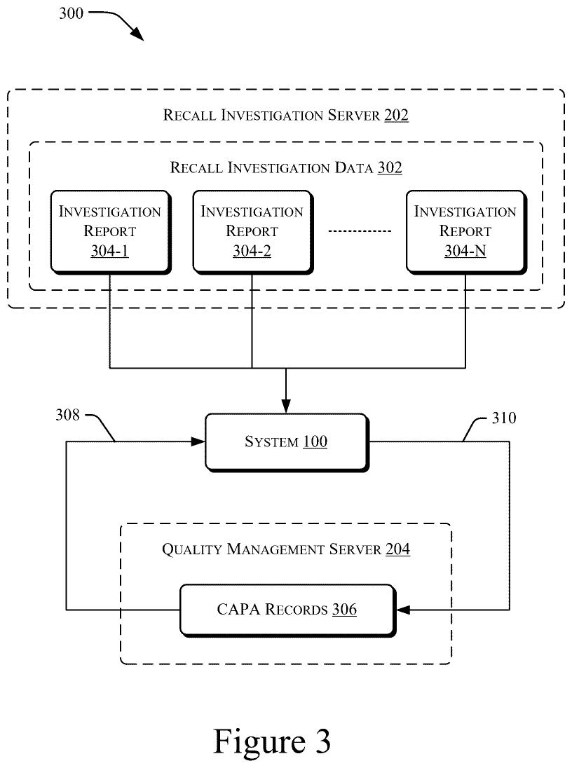

FIG. 3 illustrates a computing environment 300 implementing the CAPA configuration system 100 for configuring a CAPA record corresponding to a recall decision investigation, according to an example. In one example, the computing environment 300 may include the system 100, the recall investigation server 202, and the quality management server 204.

The recall investigation server 202 may be configured to store recall investigation data corresponding to each of a plurality of recall decision investigations conducted by an organization. For instance, the recall investigation server 202 may store recall investigation data 302 corresponding to a recall decision investigation conducted by the organization. Although recall investigation data 302 corresponding to a single recall decision investigation has been depicted in FIG. 3, the recall investigation server 202 may store similar recall investigation data corresponding to each recall decision investigation conducted by the organization. The recall investigation data 302 may include one or more investigation reports 304-1, 304-2,..., 304-N having investigation data associated with the recall decision investigation, where N may be a natural number. The one or more investigation reports 304-1, 304-2,..., 304-N may be individually referred to as investigation report 304 and collectively referred to as investigation reports 304. Although at least investigation reports 304-1, 304-2, . . . , 304-N have been depicted in FIG. 3, the present subject matter may be applicable to any number of investigation reports equal to or greater than one. The investigation data may be detailed information, such as analysis results, findings, conclusions, and recommendations, gathered during the recall decision investigation. Thus, the investigation reports 304 may serve as comprehensive records of the recall decision investigation.

The quality management server 204 may be configured to centralize and manage quality-related processes, data, and documentation associated with the organization, such as CAPA records 306 of corrective and preventive actions (CAPA) executed or to be executed by the organization. Thus, the quality management server 204 may store CAPA data corresponding to each of the CAPA records 306. The CAPA data corresponding to a CAPA record may include information contained within the CAPA record. The information contained within the CAPA record may include a plurality of headers within the CAPA record and header data present within each of the plurality of headers. Each of the plurality of headers may represent a particular aspect of the CAPA record and the corresponding header data may be information regarding the particular aspect.

The system 100 may be utilized for CAPA configuration when a CAPA configuration request is triggered by a user of the organization. For instance, upon receiving a CAPA configuration request corresponding to the recall decision investigation, the system 100 may obtain the investigation reports 304 associated with the recall decision investigation from the recall investigation server 202. Further, the system 100 may obtain the CAPA data corresponding to each of the CAPA records 306 from the quality management server 204 through path 308.

The system 100 may analyze the investigation data within the investigation reports 304 and the CAPA data corresponding to each of the CAPA records 306 to ascertain whether any CAPA record, from amongst the CAPA records 306, is semantically similar to at least a part of the investigation data. Upon ascertaining a CAPA record, from the CAPA records 306, to be semantically similar to at least a part of the investigation data, instead of creating a new CAPA record, the system 100 may update the CAPA record by incorporating at least a subset of the investigation data to generate an updated CAPA record. The system 100 may link the updated CAPA record to the recall decision investigation by transmitting the updated CAPA record to the quality management server 204 through path 310 for updating the CAPA records 306 stored within the quality management server 204.

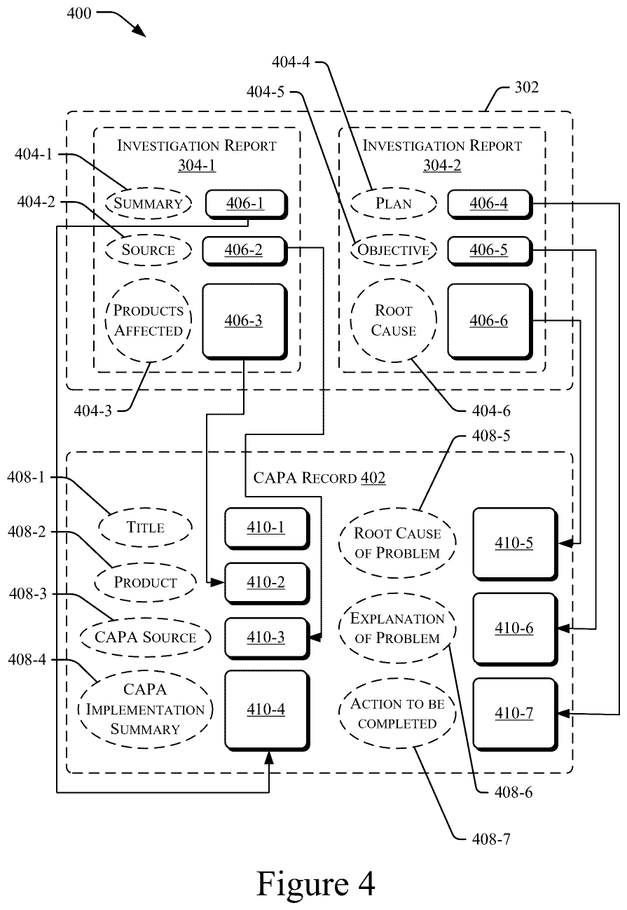

Upon ascertaining that no pre-existing CAPA record is semantically similar to at least a part of the investigation data, the system 100 may create a new CAPA record by incorporating at least a subset of the investigation data. The system 100 may link the new CAPA record to the recall decision investigation by transmitting the new CAPA record to the quality management server 204 through the path 310 for updating the CAPA records 306 stored within the quality management server 204. Thus, the system 100 may communicate with the recall investigation server 202 and the quality management server 204 for autonomously configuring a CAPA record corresponding to a recall decision investigation. The process followed by the system 100 for creating the new CAPA record and updating the CAPA record to generate the updated CAPA record, is further described with the help of FIG. 4.

FIG. 4 illustrates a schematic diagram 400 depicting an exemplary field-header mapping for configuring a CAPA record corresponding to a recall decision investigation, according to an example. The exemplary field-header mapping may be implemented by the system 100 for creating a new CAPA record and for updating a pre-existing CAPA record to generate an updated CAPA record.

The schematic diagram 400 depicts the recall investigation data 302 and a CAPA record 402. The recall investigation data 302 may include one or more investigation reports having investigation data associated with the recall decision investigation. The investigation data may comprise a plurality of fields and field data corresponding to each of the plurality of fields. Each of the plurality of fields may represent a specific aspect of the recall decision investigation, and the corresponding field data may provide relevant information gathered during the recall decision investigation regarding the specific aspect. For instance, as exemplarily illustrated in FIG. 4, the recall investigation data 302 may include a first investigation report 304-1 and a second investigation report 304-2 corresponding to the recall decision investigation. The investigation data may include a first field 404-1 as “summary”, a second field 404-2 as “source”, and a third field 404-3 as “products affected”, a fourth field 404-4 as “plan”, a fifth field 404-5 as “objective”, and a sixth field 404-6 as “root cause”. The first field 404-1, the second field 404-2, and the third field 404-3 are present within the first investigation report 304-1. Further, the fourth field 404-4, the fifth field 404-5, and the sixth field 404-6 are present within the second investigation report 304-2. Although, in FIG. 4, three fields have been depicted in each of the first investigation report 304-1 and the second investigation report 304-2, the investigation reports may have any number of fields greater than or equal to one. Further, different investigation reports may have same or different number of fields. Furthermore, although the first investigation report 304-1 and the second investigation report 304-2 have been depicted to include fields related to different aspects, different investigation reports may also have at least some fields related to same aspect.

The investigation data may further include first field data 406-1 corresponding to the first field 404-1, second field data 406-2 corresponding to the second field 404-2, third field data 406-3 corresponding to the third field 404-3, fourth field data 406-4 corresponding to the fourth field 404-4, fifth field data 406-5 corresponding to the fifth field 404-5, and sixth field data 406-6 corresponding to the sixth field 404-6.

The CAPA record 402 may be obtained or identified by the system 100 for generating one of the new CAPA record or the updated CAPA record. In an example, the CAPA record 402 may be a pre-existing CAPA record that may be modified to generate the updated CAPA record. In another example, the CAPA record 402 may be a pre-defined CAPA format that may be updated to generate the new CAPA record. CAPA data corresponding to the CAPA record 402 may comprise a plurality of headers within the CAPA record 402 and header data corresponding to each of the plurality of headers. Each of the plurality of headers may represent a particular aspect of the CAPA record 402. When the CAPA record 402 is the pre-defined CAPA format, the corresponding header data within each of the plurality of headers may be blank, awaiting input. When the CAPA record 402 is the pre-existing CAPA record, the corresponding header data within a header of the plurality of headers may either be blank awaiting input, or be pre-populated with pertinent information regarding the particular aspect represented by the header.

For instance, as exemplarily illustrated in FIG. 4, the CAPA data within the CAPA record 402 may include a first header 408-1 as “title”, a second header 408-2 as “product”, and a third header 408-3 as “CAPA source”, a fourth header 408-4 as “CAPA implementation summary”, a fifth header 408-5 as “root cause of problem”, a sixth header 408-6 as “explanation of problem”, and a seventh header 408-7 as “action to be completed”. Although, in FIG. 4, seven headers have been depicted, the CAPA data may include any number of headers greater than or equal to one. Further, different CAPA records may have same or different number of headers. The CAPA data may further include first header data 410-1 corresponding to the first header 408-1, second header data 410-2 corresponding to the second header 408-2, third header data 410-3 corresponding to the third header 408-3, fourth header data 410-4 corresponding to the fourth header 408-4, fifth header data 410-5 corresponding to the fifth header 408-5, sixth header data 410-6 corresponding to the sixth header 408-6, and seventh header data 410-7 corresponding to the seventh header 408-7.

The plurality of fields may be semantically compared with the plurality of headers by the system 100 to identify semantically similar fields and headers. That is, the plurality of fields may be semantically compared with the plurality of headers by the system 100 to create a field-header mapping based on sematic similarity. For instance, the second header 408-2 may have a semantically similar field, i.e., the third field 404-3 in the investigation data. Similarly, the third header 408-3 may have a semantically similar field, i.e., the second field 404-2 in the investigation data. Further, the fourth header 408-4 may have a semantically similar field, i.e., the first field 404-1 in the investigation data. Similarly, the fifth header 408-5, the sixth header 408-6, and the seventh header 408-7, may have semantically similar fields, i.e., the sixth field 404-6, the fifth field 404-5, and the fourth field 404-4, respectively, in the investigation data. Further, the first header 408-1 may be identified to not have semantic similarity to any of the plurality of fields.

Once the semantically similar fields and headers are identified, the system 100 may modify or update the CAPA record 402 in accordance with the field-header mapping to generate one of the new CAPA record or the updated CAPA record. For instance, for modifying or updating the CAPA record 402, the second header data 410-2 may be modified or updated to include data from the third field data 406-3. Similarly, the third header data 410-3 may be modified or updated to include data from the second field data 406-2. Further, the fourth header data 410-4 may be modified or updated to include data from the first field data 406-1, and the fifth header data 410-5 may be modified or updated to include data from the sixth field data 406-6. Furthermore, the sixth header data 410-6 may be modified or updated to include data from the fifth field data 406-5, and the seventh header data 410-7 may be modified or updated to include data from the fourth field data 406-4. Further, any semantically similar field has not been identified corresponding to the first header 408-1, the first header data 410-1 may not be modified or updated. Although a single field has been depicted to have sematic similarity to a single header, multiple fields may also be identified to have sematic similarity to a single header. In case multiple fields are identified to have sematic similarity to a single header, the system 100 may either automatically update the header data using the data merging techniques or the system 100 may seek input from a user of the organization for modifying or updating the header data.

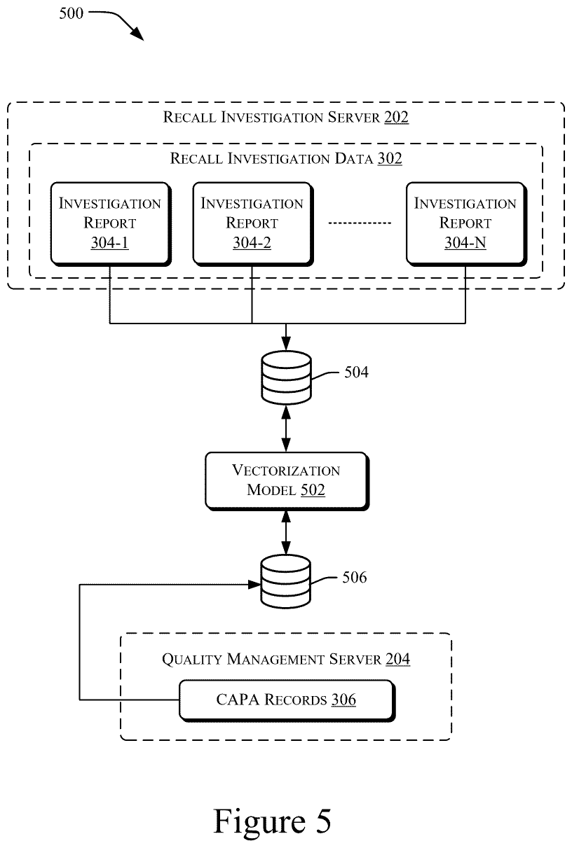

FIG. 5 illustrates a computing environment 500 implementing a vectorization model 502 to store data required for configuring a CAPA record corresponding to a recall decision investigation conducted in an organization, according to an example. In one example, the computing environment 500 may include the recall investigation server 202, the quality management server 204, the vectorized model 502, a first vector database 504, and a second vector database 506. In an example, the first vector database 504 may be associated with an investigation platform utilized by the organization for conducting recall decision investigations. The investigation platform may be managed through the recall investigation server 202. In an example, the second vector database 506 may be associated with a quality management platform utilized by the organization for managing the CAPA records 306. The investigation platform may be managed through the quality management server 204. The recall investigation data 302 having the investigation reports 304 associated with the recall decision investigation may be stored in the first vector database 504. The CAPA records 306 maintained by the quality management server 204 may be stored in the second vector database 506.

In an example, the vectorization model 502 may be a machine-learning (ML) model trained for creating vector embeddings based on data analysis. Thus, the vectorization model 502 may allow for efficient conversion of textual and numerical data from investigation reports corresponding to the recall decision investigations and the CAPA records 306 into a format suitable for similarity comparison and retrieval by the system 100.

In operation, the vectorization model 502 may obtain a plurality of investigation reports, such as the investigation reports 304, corresponding to each of a plurality of historical recall decision investigations conducted in the organization. In an example, the plurality of investigation reports may be obtained from the recall investigation server 202.

For each historical recall decision investigation of the plurality of historical recall decision investigations, the vectorization model 502 may analyze prior investigation data within the plurality of investigation reports corresponding to the historical recall decision investigation to generate vectorized prior investigation data. The vectorization model 502 may then store the vectorized prior investigation data associated with the plurality of historical recall decision investigations in the first vector database 504. In an example, the vectorized prior investigation data may be indexed in the first vector database 504 using a product identifier, an investigation identifier, and an investigation report identifier. The product identifier may be an identifier of a particular product to which the investigation data relates. The investigation identifier may be an identifier of a particular recall decision investigation to which the investigation data corresponds. The investigation report identifier may be an identifier of a particular investigation report within which the investigation data is present. Storing the vectorized prior investigation data in the first vector database 504 allows the organization to maintain a searchable history of the plurality of historical recall decision investigations.

Further, the vectorization model 502 may obtain CAPA data corresponding to each of the CAPA records 306, alternatively referred to as the pre-existing CAPA records, associated with the organization. In an example, the CAPA data may be obtained from the quality management server 204. The vectorization model 502 may then analyze the CAPA data corresponding to each of the CAPA records 306 to generate vectorized CAPA data. The vectorization model 502 may then store the vectorized CAPA data associated with the CAPA records in the second vector database 506. In an example, the vectorized CAPA data may be indexed in the second vector database 506 using an organization identifier, a product identifier, and a CAPA identifier. The organization identifier may be an identifier of a particular organization with which the CAPA data is associated. The product identifier may be an identifier of a particular product to which the CAPA data relates. The CAPA identifier may be an identifier of a particular CAPA record within which the CAPA data is present. Storing the vectorized CAPA data in the second vector database 506 allows the organization to maintain a searchable history of the CAPA records 306.

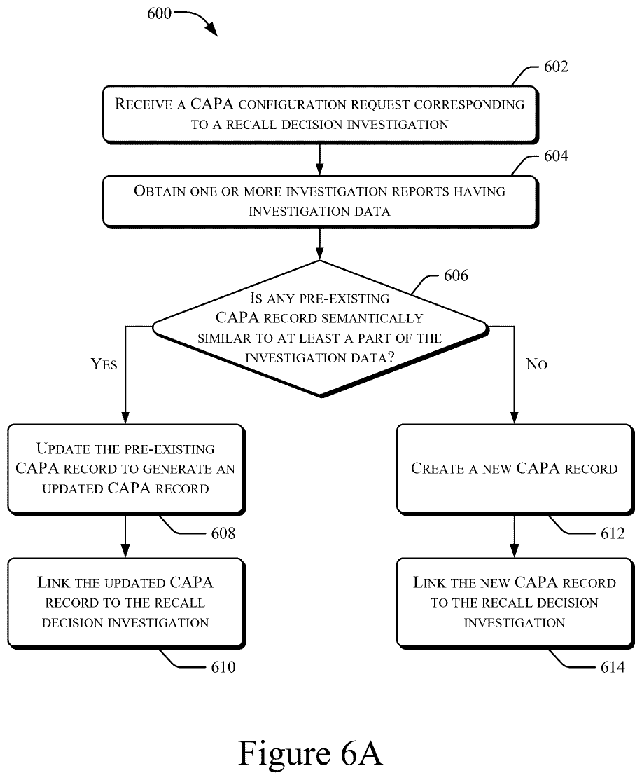

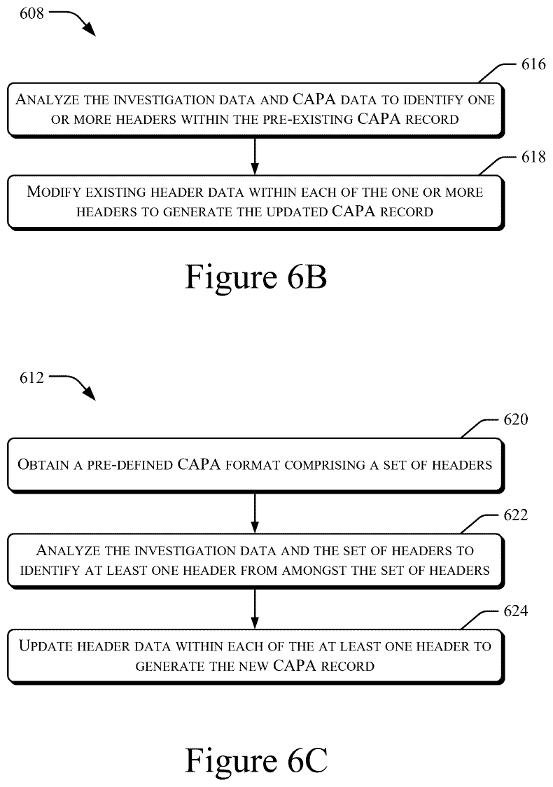

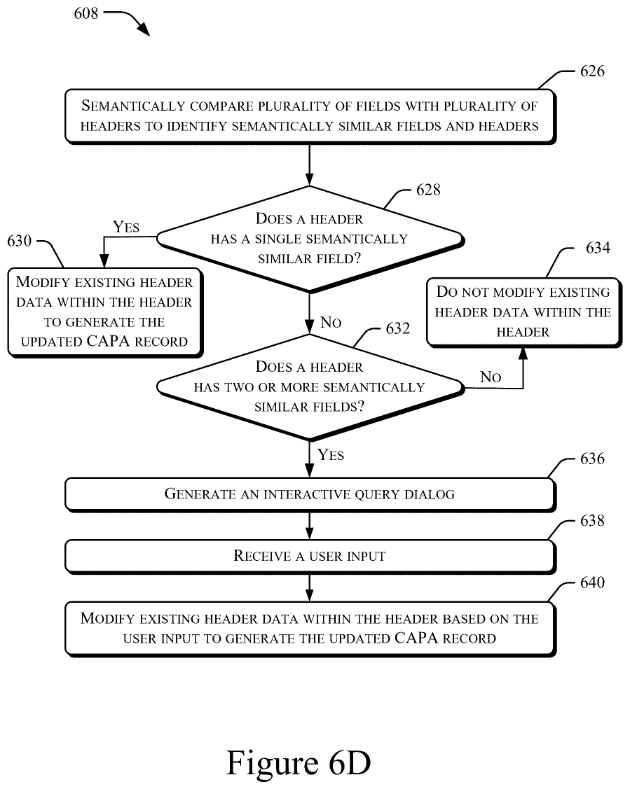

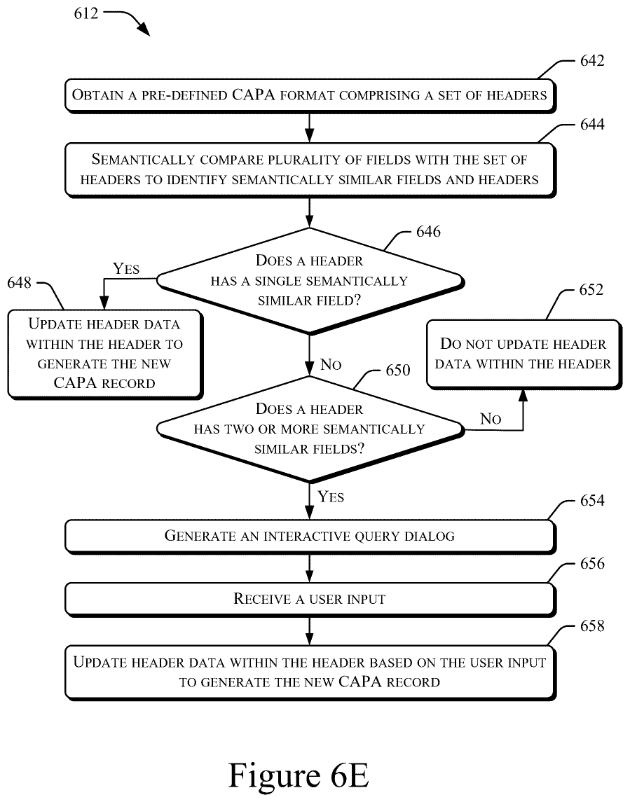

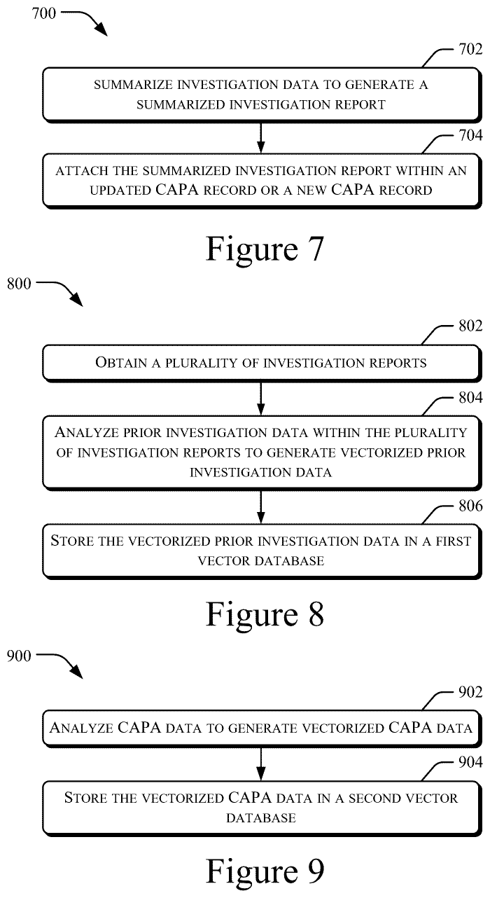

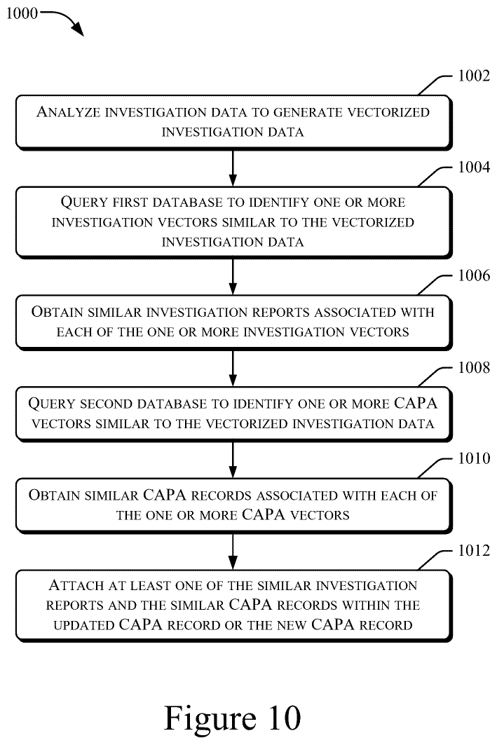

FIG. 6A, FIG. 6B, FIG. 6C, FIG. 6D, FIG. 6E, FIG. 7, FIG. 8, FIG. 9, and FIG. 10 illustrate example methods 600, 608, 612, 608, 612, 700, 800, 900, and 1000, respectively, for configuring a CAPA record corresponding to a recall decision investigation, attaching relevant documents within the CAPA record configured for the recall decision investigation, and storing CAPA data and prior investigation data required for configuring the CAPA record. The order in which the methods are described is not intended to be construed as a limitation, and any number of the described method blocks may be combined in any order to implement the methods, or an alternative method. Further, the methods 600, 608, 612, 700, 800, 900, and 1000 may be implemented by processing resource or computing device(s) through any suitable hardware, non-transitory machine-readable instructions, or combination thereof.

It may also be understood that methods 600, 608, 612, 700, 800, 900, and 1000 may be performed by programmed computing devices, such as the system 100 or the vectorization model 502, as depicted in FIG. 1, FIG. 2, FIG. 3, and FIG. 5. Furthermore, the methods 600, 608, 612, 700, 800, 900, and 1000 may be executed based on instructions stored in a non-transitory computer-readable medium, as will be readily understood. The non-transitory computer-readable medium may include, for example, digital memories, magnetic storage media, such as one or more magnetic disks and magnetic tapes, hard drives, or optically readable digital data storage media. While the methods 600, 608, 612, 700, 800, 900, and 1000 are described below with reference to the system 100 or the vectorization model 502 as described above; other suitable systems for the execution of these methods may also be utilized. Additionally, implementation of the methods 600, 608, 612, 700, 800, 900, and 1000 is not limited to such examples.

FIG. 6A illustrates the method 600 for configuring a CAPA record corresponding to a recall decision investigation, according to an example.

At block 602, a CAPA configuration request corresponding to the recall decision investigation conducted in the organization may be received. The CAPA configuration request may be initiated by a user through any electronic device, such as a laptop or a mobile device. For example, a user interface, such as a graphical user interface (GUI) or an application programming interface (API), accessible through the electronic device may be provided to the user for submitting the CAPA configuration request.

At block 604, one or more investigation reports having investigation data associated with the recall decision investigation may be obtained. The one or more investigation reports may be interchangeably referred to as the investigation reports. The investigation data may be detailed information, such as analysis results, findings, conclusions, and recommendations, gathered during the recall decision investigation. Thus, the investigation reports may serve as comprehensive records of the recall decision investigation. In an example, the investigation reports may be obtained from a recall investigation server, say the recall investigation server 202, utilized by the organization for conducting recall decision investigations. In another example, the investigation reports may be pre-stored in a memory, say the memory 212, of the system 100 and may be obtained from the memory.

In an example, the investigation data may comprise a plurality of fields and field data corresponding to each of the plurality of fields. Each of the plurality of fields may represent a specific aspect of the recall decision investigation, and the corresponding field data may provide relevant information gathered during the recall decision investigation regarding the specific aspect. For example, a first field in the investigation data may be “root cause” and the corresponding field data may be “analysis revealed that the mixing process was not maintaining uniform temperature, leading to uneven distribution of the active ingredient”, describing the root cause of a concern which is investigated through the recall decision investigation. Further, a second field in the investigation data may be “plan” and the corresponding field data may be “to address the problem, we will recalibrate the mixing equipment and implement a new monitoring system for temperature control. Additionally, we will increase the frequency of in-process checks during mixing”, describing the corrective and preventive action that may address the concern is investigated through the recall decision investigation.

At block 606, it is ascertained whether any pre-existing CAPA record, from amongst a plurality of pre-existing CAPA records, is semantically similar to at least a part of the investigation data. For ascertaining whether any pre-existing CAPA record is semantically similar to at least a part of the investigation data, the investigation data and CAPA data corresponding to each of the plurality of pre-existing CAPA records may be analyzed. In an example, the CAPA data corresponding to a pre-existing CAPA record may include information contained within the pre-existing CAPA record. The information contained within the pre-existing CAPA record may include a plurality of headers within the pre-existing CAPA record and existing header data present within each of the plurality of headers. Each of the plurality of headers may represent a particular aspect of the pre-existing CAPA record and the corresponding existing header data may be information regarding the particular aspect. In an example, the CAPA data corresponding to each of the plurality of pre-existing CAPA records may be obtained from a quality management server, say the quality management server 204, utilized by the organization to manage the plurality of pre-existing CAPA records associated with the organization. In another example, the CAPA data may be pre-stored in the memory of the system 100 and may be obtained from the memory.

In an example, the corresponding existing header data may be blank, awaiting input. In another example, the corresponding existing header data may pre-populated with pertinent information regarding the particular aspect. For example, a first header in the pre-existing CAPA record may be “preventive action implemented” and the corresponding existing header data may be blank as no prevention action may have been formulated or implemented when the pre-existing CAPA record was last created, modified, or stored in the quality management server. Further, a second header in the pre-existing CAPA record may be “problem statement” and the corresponding existing header data may be pre-populated as “batch XYZ123 of our pain relief medication showed inconsistent active ingredient concentrations”.

In an example, the investigation data and the CAPA data may be analyzed using a large language model (LLM) to ascertain whether any pre-existing CAPA record is semantically similar to at least a part of the investigation data. In another example, the investigation data and the CAPA data may be stored in a vectorized form in one or more vector databases. Vectors corresponding to the investigation data may be compared with vectors corresponding to the CAPA data to ascertain whether any pre-existing CAPA record is semantically similar to at least a part of the investigation data. In an example, for ascertaining whether any pre-existing CAPA record is semantically similar to at least a part of the investigation data, semantic comparisons may be performed either through the LLM or using the vectors. Further, synonym mappings, received from a user of the organization, may also be utilized while performing the semantic comparison through the LLM or using the vectors. The synonym mappings may augment semantic understanding capabilities of both the LLM-based and vector-based approaches. The synonym mappings may provide synonymous terminologies specifically in the context of the organization, enabling the CAPA generation engine 110 to more accurately identify semantically similar pre-existing CAPA records. In an example, a pre-existing CAPA record may be identified to be semantically similar to at least a part of the investigation data when the investigation data and the CAPA data pertain to similar products of the organization, similar quality concern affecting the organization, and similar corrective and preventive actions. In another example, the pre-existing CAPA record and the investigation data may be associated with the same recall decision investigation, such as when the pre-existing CAPA record was prematurely created before the recall decision investigation was fully concluded, or when additional findings or conclusions emerge related to the recall decision investigation subsequent to the creation and storage of the pre-existing CAPA record.

In case, a pre-existing CAPA record, from the plurality of pre-existing CAPA records, is ascertained to be semantically similar to at least a part of the investigation data, (‘Yes’ path from block 606), the pre-existing CAPA record may be updated to generate an updated CAPA record, at block 608. The pre-existing CAPA record may be updated by incorporating at least a subset of the investigation data. Thus, instead of creating an entirely new CAPA record, relevant information, i.e., the subset of the investigation data, may be identified from the investigation data, and the relevant information may be incorporated into the pre-existing CAPA record, thereby combining pre-populated information within the pre-existing CAPA record with new findings from the investigation data.

At block 610, the updated CAPA record may be linked to the recall decision investigation. In an example, linking the updated CAPA record to the recall decision investigation may include transmitting the updated CAPA record to the quality management server for updating CAPA records managed by the quality management server.

In case, no pre-existing CAPA record, from the plurality of pre-existing CAPA records, is ascertained to be semantically similar to at least a part of the investigation data, (‘No’ path from block 606), a new CAPA record may be created, at block 612. The new CAPA record may be created by incorporating at least a subset of the investigation data.

At block 614, the new CAPA record may be linked to the recall decision investigation. In an example, linking the new CAPA record to the recall decision investigation may include transmitting the new CAPA record to the quality management server for updating CAPA records managed by the quality management server. Thus, the present subject matter eliminates the need for the user to log-in separately to the quality management server for configuring the CAPA record.

FIG. 6B illustrates the method 608 for updating the pre-existing CAPA record to generate the updated CAPA record at block 608 of FIG. 6A, according to an example.

For updating the pre-existing CAPA record, at block 616, the investigation data and CAPA data corresponding to the pre-existing CAPA record may be analyzed to identify one or more headers, from amongst the plurality of headers, within the pre-existing CAPA record for which semantically relatable data is present within the investigation data. The investigation data may include semantically relatable corresponding subset data for each of the one or more headers. In an example, natural language processing techniques may be utilized for effectively identifying the one or more headers and the semantically relatable corresponding subset data for each of the one or more headers.

At block 618, existing header data within each of the one or more headers may be modified to include the corresponding subset data from the investigation data to generate the updated CAPA record. In an example, the corresponding subset data may be included in the existing header data through various data merging techniques, such as intelligent integration, chronological appending, hierarchical structuring, differential highlighting, and semantic merging, to ensure coherent, non-redundant, and contextually appropriate inclusion of the corresponding subset data with the existing header data. In an example, if the corresponding existing header data within a header of the one or more headers is pre-populated with some information, the corresponding existing header data may be automatically modified using the data merging techniques, without any user input. In another example, if the existing header data within the header of the one or more headers is pre-populated with some information, a user may be prompted to indicate a particular merging option from a plurality of merging options and modify the corresponding existing header data in accordance with the particular merging option indicated by the user. For instance, the user may choose to simply append the corresponding subset data without changing pre-populated information within the existing header data. In another instance, the user may choose to replace the pre-populated information within the existing header data with the corresponding subset data.

FIG. 6C illustrates the method 612 for creating the new CAPA record at block 612 of FIG. 6A, according to an example.

For creating the new CAPA record, at block 620, a pre-defined CAPA format associated with the organization may be obtained. The pre-defined CAPA format may be defined as standardized CAPA templates customarily used by the organization for documenting CAPA records associated with the organization. The pre-defined CAPA format may comprise of a set of headers. For example, the pre-defined CAPA format may comprise of a first header “title”, a second header “product”, a third header “CAPA source”, a fourth header “CAPA implementation summary”, a fifth header “root cause of problem”, a sixth header “explanation of problem”, and a seventh header “action to be completed”. In an example, the pre-defined CAPA format may be obtained from a user associated with the organization. In another example, the pre-defined CAPA format may be pre-stored in the memory of the system 100 and may be obtained from the memory.

At block 622, the investigation data and the set of headers may be analyzed to identify at least one header, from amongst the set of headers, for which semantically relatable data is present within the investigation data. The investigation data may include semantically relatable corresponding subset data for each of the at least one header. In an example, natural language processing techniques may be utilized for effectively identifying the at least one headers and the semantically relatable corresponding subset data for each of the at least one header.

At block 624, header data within each of the at least one header may be updated to generate the new CAPA record. In an example, the header data within each of the at least one header may be updated to include the corresponding subset data from the investigation data to generate the new CAPA record.

FIG. 6D illustrates the method 608 for updating the pre-existing CAPA record to generate the updated CAPA record at block 608 of FIG. 6A, according to an example.

For updating the pre-existing CAPA record, at block 626, the plurality of fields may be semantically compared with the plurality of headers corresponding to the pre-existing CAPA record to identify semantically similar fields and headers. For example, a first field “summary” within the investigation data may be identified to be semantically similar to a first header “CAPA implementation summary” within the pre-existing CAPA record. Further, a second field “objective” within the investigation data may be identified to be semantically similar to a second header “explanation of problem” within the pre-existing CAPA record. Further, a third field “root cause type” and a fourth field “root cause” within the investigation data may be identified to be semantically similar to a third header “root cause of problem” within the pre-existing CAPA record.

At block 628, for each header of the plurality of headers, it is determined whether the header has a single semantically similar field in the investigation data. For instance, the first header “CAPA implementation summary” may be determined to have a single semantically similar field, i.e., the first field “summary”, in the investigation data. Further, the second header “explanation of problem” may be determined to have a single semantically similar field, i.e., the second field “objective”, in the investigation data.

In case, it is determined that the header has a single semantically similar field in the investigation data, (‘Yes’ path from block 628), the existing header data within the header may be modified to include the field data corresponding to the semantically similar field to generate the updated CAPA record, at block 630. In an example, the existing header data within the header may be modified to include the field data corresponding to the semantically similar field for each header of the plurality of headers, determined to have a single semantically similar field in the investigation data. For example, first field data corresponding to the first field “summary” may be incorporated in the corresponding existing header data within the first header “CAPA implementation summary”. Further, second field data corresponding to the second field “objective” may be incorporated in the corresponding existing header data within the second header “explanation of problem”.

In case, it is determined that the header does not have a single semantically similar field in the investigation data, (‘No’ path from block 628), it is determined whether the header has two or more semantically similar fields in the investigation data, at block 632. For instance, the third header “root cause of problem” may be determined to have two semantically similar fields, i.e., the third field “root cause type” and the fourth field “root cause”, in the investigation data.

In case, it is determined that the header does not have two or more semantically similar fields in the investigation data, (‘No’ path from block 632), the existing header data within the header may not be modified, at block 634. That is, the existing header data within the header may be left unchanged.

In case, it is determined that the header has two or more semantically similar fields in the investigation data, (‘Yes’ path from block 632), an interactive query dialog may be generated to seek a user input for selecting fields from the two or more semantically similar fields and prioritizing the selected fields, at block 636. In an example, the interactive query dialog may be generated for each header of the plurality of headers, determined to have two or more semantically similar fields in the investigation data. For example, in response to the interactive query dialog, the user may select one or both of the third field “root cause type” and the fourth field “root cause” for modifying the existing header data. If the user selects both the third field “root cause type” and the fourth field “root cause”, the user may also prioritize the selected fields by providing a hierarchical arrangement of the third field and the fourth field.

At block 638, a user input specifying the hierarchical arrangement of selected fields from the two or more semantically similar fields may be received. In an example, the user input may be received through an interactive user interface accessed by the user through any electronic device to provide the user input.

Subsequently, at block 640, the existing header data within the header may be modified to include the field data corresponding to the selected fields in accordance with the hierarchical arrangement to generate the updated CAPA record. The updated CAPA record may thus be a version of the pre-existing CAPA record once each header, from the plurality of headers, having semantically relatable data in the investigation data is modified using the investigation data.

FIG. 6E illustrates the method 612 for creating the new CAPA record at block 612 of FIG. 6A, according to an example.

For creating the pre-existing CAPA record, at block 642, a pre-defined CAPA format associated with the organization may be obtained. The pre-defined CAPA format may be defined as standardized CAPA templates customarily used by the organization for documenting CAPA records associated with the organization. The pre-defined CAPA format may comprise of a set of headers. For example, the pre-defined CAPA format may comprise of a first header “title”, a second header “product”, a third header “CAPA source”, a fourth header “CAPA implementation summary”, a fifth header “root cause of problem”, a sixth header “explanation of problem”, and a seventh header “action to be completed”. In an example, the pre-defined CAPA format may be obtained from a user associated with the organization. In another example, the pre-defined CAPA format may be pre-stored in the memory of the system 100 and may be obtained from the memory.

At block 644, the plurality of fields may be semantically compared with the set of headers to identify semantically similar fields and headers. For example, the first field “summary” within the investigation data may be identified to be semantically similar to the fourth header “CAPA implementation summary” within the pre-defined CAPA format. Further, the second field “objective” within the investigation data may be identified to be semantically similar to the sixth header “explanation of problem” within the pre-defined CAPA format. Further, a third field “root cause type” and a fourth field “root cause” within the investigation data may be identified to be semantically similar to the fourth header “root cause of problem” within the pre-defined CAPA format.

At block 646, for each header of the set of headers, it is determined whether the header has a single semantically similar field in the investigation data. For instance, the fourth header “CAPA implementation summary” may be determined to have a single semantically similar field, i.e., the first field “summary”, in the investigation data. Further, the sixth header “explanation of problem” may be determined to have a single semantically similar field, i.e., the second field “objective”, in the investigation data.

In case, it is determined that the header has a single semantically similar field in the investigation data, (‘Yes’ path from block 646), header data within the header may be updated to include the field data corresponding to the semantically similar field to generate the new CAPA record, at block 648. In an example, the header data within the header may be updated to include the field data corresponding to the semantically similar field for each header of the set of headers, determined to have a single semantically similar field in the investigation data. For example, first field data corresponding to the first field “summary” may be incorporated in the corresponding header data within the first header “CAPA implementation summary”. Further, second field data corresponding to the second field “objective” may be incorporated in the corresponding header data within the second header “explanation of problem”.

In case, it is determined that the header does not have a single semantically similar field in the investigation data, (‘No’ path from block 646), it is determined whether the header has two or more semantically similar fields in the investigation data, at block 650. For instance, the fourth header “root cause of problem” may be determined to have two semantically similar fields, i.e., the third field “root cause type”and the fourth field “root cause”, in the investigation data.

In case, it is determined that the header does not have two or more semantically similar fields in the investigation data, (‘No’ path from block 650), the header data within the header may not be updated, at block 652. That is, the header data within the header may be left unchanged.

In case, it is determined that the header has two or more semantically similar fields in the investigation data, (‘Yes’ path from block 650), an interactive query dialog may be generated to seek a user input for selecting fields from the two or more semantically similar fields and prioritizing the selected fields, at block 654. In an example, the interactive query dialog may be generated for each header of the set of headers, determined to have two or more semantically similar fields in the investigation data. For example, in response to the interactive query dialog, the user may select one or both of the third field “root cause type” and the fourth field “root cause” for modifying the corresponding header data. If the user selects both the third field “root cause type” and the fourth field “root cause”, the user may also prioritize the selected fields by providing a hierarchical arrangement of the third field and the fourth field.

At block 656, a user input specifying the hierarchical arrangement of selected fields from the two or more semantically similar fields may be received. In an example, the user input may be received through an interactive user interface accessed by the user through any electronic device to provide the user input.

Subsequently, at block 658, the header data within the header may be modified to include the field data corresponding to the selected fields in accordance with the hierarchical arrangement to generate the new CAPA record. The new CAPA record may thus be a version of the pre-defined CAPA format once each header, from the set of headers, having semantically relatable data in the investigation data is updated using the investigation data.

FIG. 7 illustrates the method 700 for attaching relevant documents within a CAPA record configured for a recall decision investigation, according to an example.

At block 702, the investigation data may be summarized to generate a summarized investigation report. In an example, natural language processing techniques may be utilized for summarizing the investigation data. In an example, while summarizing the investigation data, the context of the investigation data may be maintained and the investigation data may be reformulated using different words and shorter sentences. In an example, the summarized investigation report may capture key findings, conclusions, and recommendations from the full investigation data.

At block 704, the summarized investigation report may be attached within an updated CAPA record or a new CAPA record that is linked to the recall decision investigation. In an example, the summarized investigation report may be attached in different file formats, such as a portable document format (PDF) or an editable format. In an example, the summarized investigation report may be attached in a default file format, unless the user specifically provides inputs regarding the desired file format.

FIG. 8 illustrates the method 800 for storing prior investigation data required for configuring a CAPA record corresponding to a recall decision investigation, according to an example.

For efficient semantical comparison, all historical investigation reports and historical CAPA records associated with the organization may be stored in vector databases in a vectorized form. In an example, at block 802, a plurality of investigation reports corresponding to each of a plurality of historical recall decision investigations conducted in the organization may be obtained. In an example, the plurality of investigation reports may be obtained from a recall investigation server, say the recall investigation server 202. In another example, the plurality of investigation reports may be pre-stored in the memory of the system 100 and may be obtained from the memory.

At block 804, for each historical recall decision investigation of the plurality of historical recall decision investigations, prior investigation data within the plurality of investigation reports corresponding to the historical recall decision investigation may be analyzed to generate vectorized prior investigation data. In an example, a vectorization model, say the vectorization model 502, may be utilized for creating vector embeddings of the prior investigation data to generate the vectorized prior investigation data.

At block 806, the vectorized prior investigation data associated with the plurality of historical recall decision investigations may be stored in a first vector database, say the first vector database 504, associated with an investigation platform utilized by the organization for conducting recall decision investigations. The investigation platform may be managed through the recall investigation server. Storing the vectorized prior investigation data in the first vector database allows the organization to maintain a searchable history of the plurality of historical recall decision investigations.

FIG. 9 illustrates the method 900 for storing CAPA data required for configuring a CAPA record corresponding to a recall decision investigation, according to an example.

For efficient semantical comparison, all historical investigation reports and historical CAPA records associated with the organization may be stored in vector databases in a vectorized form. In an example, at block 902, CAPA data corresponding to each of a plurality of pre-existing CAPA records may be analyzed to generate vectorized CAPA data. In an example, the CAPA data may be obtained from a quality management server, say the quality management server 204. In another example, the CAPA data may be pre-stored in the memory of the system 100 and may be obtained from the memory. In an example, a vectorization model, say the vectorization model 502, may be utilized for creating vector embeddings of the CAPA data to generate the vectorized CAPA data.

At block 904, the vectorized CAPA data associated with the plurality of pre-existing CAPA records may be stored in a second vector database, say the second vector database 506, associated with a quality management platform utilized by the organization for managing CAPA records. The quality management platform may be managed through the quality management server. Storing the vectorized CAPA data in the second vector database allows the organization to maintain a searchable history of the plurality of pre-existing CAPA records.

FIG. 10 illustrates the method 1000 for attaching relevant documents within a CAPA record configured for a recall decision investigation conducted in an organization, according to another example.

At block 1002, investigation data associated with the recall decision investigation may be analyzed to generate vectorized investigation data. The investigation data may be detailed information, such as analysis results, findings, conclusions, and recommendations, gathered during the recall decision investigation. In an example, a vectorization model, say the vectorization model 502, may be utilized for creating vector embeddings of the investigation data to generate the vectorized investigation data.

At block 1004, a first vector database, say the first vector database 504, may be queried to identify one or more investigation vectors, from vectorized prior investigation data within the first vector database, which are similar to the vectorized investigation data. In an example, the first vector database may be associated with an investigation platform utilized by the organization for conducting recall decision investigations. The investigation platform may be managed through a recall investigation server, say the recall investigation server 202. The vectorized prior investigation data may be a vectorized form of prior investigation data within a plurality of investigation reports corresponding to each of a plurality of historical recall decision investigations.

At block 1006, similar investigation reports, from the plurality of investigation reports of the plurality of historical recall decision investigations, associated with each of the one or more investigation vectors may be obtained. In an example, the similar investigation reports may be one or more investigation reports of the plurality of investigation reports having similar vector embeddings as the vector embeddings corresponding to the investigation data.

At block 1008, a second vector database, say the second vector database 506, may be queried to identify one or more CAPA vectors, from vectorized CAPA data within the second vector database, which are similar to the vectorized investigation data. In an example, the second vector database may be associated with a quality management platform utilized by the organization to manage CAPA records of the organization. The quality management platform may be managed through a quality management server, say the quality management server 204. The vectorized CAPA data may be a vectorized form of CAPA data corresponding to each of a plurality of pre-existing reports associated with the organization.

At block 1010, similar CAPA records, from the pre-existing CAPA records, associated with each of the one or more CAPA vectors may be obtained. In an example, the similar CAPA records may be one or more CAPA record of the plurality of CAPA records having similar vector embeddings as the vector embeddings corresponding to the investigation data.

At block 1012, at least one of the similar investigation reports and the similar CAPA records may be attached within an updated CAPA record or a new CAPA record that is linked to the recall decision investigation. In an example, the similar investigation reports and the similar CAPA records may be attached in different file formats, such as a portable document format (PDF) or an editable format. In an example, the similar investigation reports and the similar CAPA records may be attached in a default file format, unless the user specifically provides inputs regarding the desired file format.

By implementing automated semantic analysis and attaching similar investigation reports and the similar CAPA records within the new CAPA record or the updated CAPA record, the present subject matter ensures that similar issues are identified and addressed consistently across the organization, reducing variability in CAPA record creation and management. Thus, the present subject matter contributes to a more efficient, effective, and proactive approach to quality management, enabling organizations to maintain high standards of product quality and safety while optimizing use of manual or computational resources.

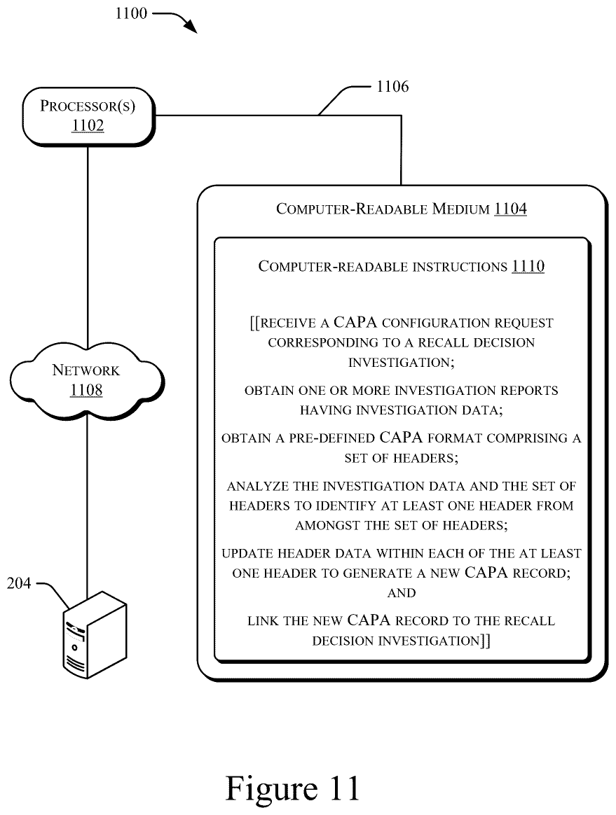

FIG. 11 illustrates a computing environment 1100 implementing a non-transitory computer-readable medium for configuring a CAPA record corresponding to a recall decision investigation, according to an example. In an example, the computing environment 1100 includes processor(s) 1102 communicatively coupled to a non-transitory computer-readable medium 1104 through a communication link 1106. In one example, the communication link 1106 may be similar to the communication network 206, as described in conjunction with the preceding figures. In an example implementation, the computing environment 1100 may be for example, the computing environment 200, the computing environment 300, or the computing environment 500. In an example, the processor(s) 1102 may have one or more processing resources for fetching and executing computer-readable instructions from the non-transitory computer-readable medium 1104. The processor(s) 1102 and the non-transitory computer-readable medium 1104 may be implemented, for example, in the system 100 or the vectorization model 502 (as has been described in conjunction with the preceding figures).

The non-transitory computer-readable medium 1104 may be, for example, an internal memory device or an external memory device. In an example implementation, the communication link 1106 may be a network communication link. The processor(s) 1102 and the non-transitory computer-readable medium 1104 may also be communicatively coupled to the quality management server 204 over a network 1108. The network 1108 may be similar to the communication network 206 described in conjunction with FIG. 2.

In an example implementation, the non-transitory computer-readable medium 1104 may include a set of computer-readable instructions 1110 which may be accessed by the processor(s) 1102 through the communication link 1106. Referring to FIG. 11, in an example, the non-transitory computer-readable medium 1104 may include instructions 1110 that may cause the processor(s) 1102 to receive a CAPA configuration request corresponding to the recall decision investigation conducted in the organization. The CAPA configuration request may be initiated by a user through any electronic device, such as a laptop or a mobile device. For example, a user interface, such as a graphical user interface (GUI) or an application programming interface (API), accessible through the electronic device may be provided to the user for submitting the CAPA configuration request.

The instructions 1110 may further cause the processor(s) 1102, in one example, to obtain one or more investigation reports having investigation data associated with the recall decision investigation. The one or more investigation reports may be interchangeably referred to as the investigation reports. The investigation data may be detailed information, such as analysis results, findings, conclusions, and recommendations, gathered during the recall decision investigation. Thus, the investigation reports may serve as comprehensive records of the recall decision investigation. In an example, the investigation reports may be obtained from a recall investigation server, say the recall investigation server 202, utilized by the organization for conducting recall decision investigations. In another example, the investigation reports may be pre-stored in a memory, say the memory 212, of the system 100 and may be obtained from the memory.

In an example, the investigation data may comprise a plurality of fields and field data corresponding to each of the plurality of fields. Each of the plurality of fields may represent a specific aspect of the recall decision investigation, and the corresponding field data may provide relevant information gathered during the recall decision investigation regarding the specific aspect. For example, a first field in the investigation data may be “root cause” and the corresponding field data may be “analysis revealed that the mixing process was not maintaining uniform temperature, leading to uneven distribution of the active ingredient”, describing the root cause of a concern which is investigated through the recall decision investigation. Further, a second field in the investigation data may be “plan” and the corresponding field data may be “to address the problem, we will recalibrate the mixing equipment and implement a new monitoring system for temperature control. Additionally, we will increase the frequency of in-process checks during mixing”, describing the corrective and preventive action that may address the concern is investigated through the recall decision investigation.

In one example, the instructions 1110 may further cause the processor(s) 1102 to obtain a pre-defined CAPA format associated with the organization. The pre-defined CAPA format may be defined as standardized CAPA templates customarily used by the organization for documenting CAPA records associated with the organization. The pre-defined CAPA format may comprise of a set of headers. For example, the pre-defined CAPA format may comprise of a first header “title”, a second header “product”, a third header “CAPA source”, a fourth header “CAPA implementation summary”, a fifth header “root cause of problem”, a sixth header “explanation of problem”, and a seventh header “action to be completed”. In an example, the pre-defined CAPA format may be obtained from a user associated with the organization. In another example, the pre-defined CAPA format may be pre-stored in the memory of the system 100 and may be obtained from the memory.

In one example, the instructions 1110 may further cause the processor(s) 1102 to analyze the investigation data and the set of headers to identify at least one header, from amongst the set of headers, for which semantically relatable data is present within the investigation data. The investigation data may include semantically relatable corresponding subset data for each of the at least one header. In an example, natural language processing techniques may be utilized for effectively identifying the at least one headers and the semantically relatable corresponding subset data for each of the at least one header.

For analyzing the investigation data and the set of headers, the instructions 1110 may cause the processor(s) 1102 to semantically compare the plurality of fields with the set of headers to identify semantically similar fields and headers. For example, a first field “summary” within the investigation data may be identified to be semantically similar to the fourth header “CAPA implementation summary” within the pre-defined CAPA format. Further, a second field “objective” within the investigation data may be identified to be semantically similar to the sixth header “explanation of problem” within the pre-defined CAPA format. Further, a third field “root cause type” and a fourth field “root cause” within the investigation data may be identified to be semantically similar to the fourth header “root cause of problem” within the pre-defined CAPA format. Each header identified to have at least one semantically similar field in the investigation data is designated as the at least one header for which semantically relatable data is present within the investigation data.

In one example, the instructions 1110 may further cause the processor(s) 1102 to update header data within each of the at least one header to generate the new CAPA record. In an example, the header data within each of the at least one header may be updated to include the corresponding subset data from the investigation data to generate the new CAPA record.

For updating the header data within each of the at least one header, the instructions 1110 may cause the processor(s) 1102 to update the header data, within each header of the at least one header having one semantically similar field in the investigation data, to include the field data corresponding to the semantically similar field to generate the new CAPA record. For example, the first field data corresponding to the first field “summary” may be incorporated in the corresponding header data within the first header “CAPA implementation summary”. Further, the second field data corresponding to the second field “objective” may be incorporated in the corresponding header data within the second header “explanation of problem”.

Further, for each header of the at least one header having two or more semantically similar fields in the investigation data, the instructions 1110 may cause the processor(s) 1102 to generate an interactive query dialog to seek a user input for selecting fields from the two or more semantically similar fields and prioritizing the selected fields. For example, the user may select one or both of the third field “root cause type” and the fourth field “root cause” for modifying the corresponding header data. If the user selects both the third field “root cause type” and the fourth field “root cause”, the user may also prioritize the selected fields by providing a hierarchical arrangement of the third field and the fourth field. The instructions 1110 may then cause the processor(s) 1102 to receive a user input specifying a hierarchical arrangement of selected fields from the two or more semantically similar fields. The instructions 1110 may then cause the processor(s) 1102 to update the header data within the header to include the field data corresponding to the selected fields in accordance with the hierarchical arrangement to generate the new CAPA record. The new CAPA record may thus be a version of the pre-defined CAPA format once each of the at least one header is updated using the investigation data.

In one example, the instructions 1110 may further cause the processor(s) 1102 to link the new CAPA record to the recall decision investigation. In an example, linking the new CAPA record to the recall decision investigation may include transmitting the new CAPA record to the quality management server 204 for updating CAPA records managed by the quality management server 204. Thus, the present subject matter eliminates the need for the user to log-in separately to the quality management server 204 for configuring the CAPA record.

In an example, once the one or more investigation reports are obtained upon receiving the CAPA configuration request, the instructions 1110 may cause the processor(s) 1102 to obtain CAPA data corresponding to each of a plurality of pre-existing CAPA records associated with the organization. In an example, the CAPA data corresponding to a pre-existing CAPA record may include information contained within the pre-existing CAPA record. In an example, the CAPA data corresponding to each of the plurality of pre-existing CAPA records may be obtained from the quality management server 204. In another example, the CAPA data may be pre-stored in the memory of the system 100 and may be obtained from the memory.

In an example, the CAPA data of each pre-existing CAPA record of the plurality of pre-existing CAPA records may comprise a plurality of headers within the pre-existing CAPA record and existing header data present within each of the plurality of headers. Each of the plurality of headers may represent a particular aspect of the pre-existing CAPA record. In an example, the corresponding existing header data may be blank, awaiting input. In another example, the corresponding existing header data may pre-populated with pertinent information regarding the particular aspect. For example, a first header in the pre-existing CAPA record may be “preventive action implemented” and the corresponding existing header data may be blank as no prevention action may have been formulated or implemented when the pre-existing CAPA record was last created, modified, or stored in the quality management server 204. Further, a second header in the pre-existing CAPA record may be “problem statement” and the corresponding existing header data may be pre-populated as “batch XYZ123 of our pain relief medication showed inconsistent active ingredient concentrations”.

The instructions 1110 may then cause the processor(s) 1102 to analyze the investigation data and the CAPA data corresponding to each of the plurality of pre-existing CAPA records to ascertain whether any pre-existing CAPA record, from amongst the plurality of pre-existing CAPA records, is semantically similar to at least a part of the investigation data. In an example, the investigation data and the CAPA data may be analyzed using a large language model (LLM) to ascertain whether any pre-existing CAPA record is semantically similar to at least a part of the investigation data. In another example, the investigation data and the CAPA data may be stored in a vectorized form in one or more vector databases. Vectors corresponding to the investigation data may be compared with vectors corresponding to the CAPA data to ascertain whether any pre-existing CAPA record is semantically similar to at least a part of the investigation data. In an example, for ascertaining whether any pre-existing CAPA record is semantically similar to at least a part of the investigation data, semantic comparisons may be performed either through the LLM or using the vectors. Further, synonym mappings, received from a user of the organization, may also be utilized while performing the semantic comparison through the LLM or using the vectors. The synonym mappings may augment semantic understanding capabilities of both the LLM-based and vector-based approaches. The synonym mappings may provide synonymous terminologies specifically in the context of the organization, enabling more accurate identification of semantically similar pre-existing CAPA records.

In an example, a pre-existing CAPA record may be identified to be semantically similar to at least a part of the investigation data when the investigation data and the CAPA data pertain to similar products of the organization, similar quality concern affecting the organization, and similar corrective and preventive actions. In another example, the pre-existing CAPA record and the investigation data may be associated with the same recall decision investigation, such as when the pre-existing CAPA record was prematurely created before the recall decision investigation was fully concluded, or when additional findings or conclusions emerge related to the recall decision investigation subsequent to the creation and storage of the pre-existing CAPA record.

Upon ascertaining that no pre-existing CAPA record is semantically similar to at least a part of the investigation data, the instructions 1110 may cause the processor(s) 1102 to generate the new CAPA record by incorporating at least a subset of the investigation data.

Upon ascertaining a pre-existing CAPA record, from the plurality of pre-existing CAPA records, to be semantically similar to at least a part of the investigation data, the instructions 1110 may cause the processor(s) 1102 to update the pre-existing CAPA record to generate an updated CAPA record, instead of creating a new CAPA record. The pre-existing CAPA record may be updated by incorporating at least a subset of the investigation data. Thus, instead of creating an entirely new CAPA record, relevant information, i.e., the subset of the investigation data, from the investigation data, may be identified and the relevant information may be incorporated into the pre-existing CAPA record, thereby combining pre-populated information within the pre-existing CAPA record with new findings from the investigation data.

In an example, for updating the pre-existing CAPA record, the instructions 1110 may cause the processor(s) 1102 to analyze the investigation data and CAPA data corresponding to the pre-existing CAPA record to identify one or more headers, from amongst the plurality of headers, within the pre-existing CAPA record for which semantically relatable data is present within the investigation data. The investigation data may include semantically relatable corresponding subset data for each of the one or more headers. In an example, natural language processing techniques may be utilized for effectively identifying the one or more headers and the semantically relatable corresponding subset data for each of the one or more headers.

For analyzing the investigation data and the CAPA data corresponding to the pre-existing CAPA record, the instructions 1110 may cause the processor(s) 1102 to semantically compare the plurality of fields with the plurality of headers corresponding to the pre-existing CAPA record to identify semantically similar fields and headers. For example, a first field “summary” within the investigation data may be identified to be semantically similar to a first header “CAPA implementation summary” within the pre-existing CAPA record. Further, a second field “objective” within the investigation data may be identified to be semantically similar to a second header “explanation of problem” within the pre-existing CAPA record. Further, a third field “root cause type” and a fourth field “root cause” within the investigation data may be identified to be semantically similar to a third header “root cause of problem” within the pre-existing CAPA record. Each header identified to have at least one semantically similar field in the investigation data may be designated as the one or more headers for which semantically relatable data is present within the investigation data.

Further, the instructions 1110 may cause the processor(s) 1102 to modify existing header data within each of the one or more headers to include the corresponding subset data from the investigation data to generate the updated CAPA record. In an example, the corresponding subset data may be included in the existing header data through various data merging techniques, such as intelligent integration, chronological appending, hierarchical structuring, differential highlighting, and semantic merging, to ensure coherent, non-redundant, and contextually appropriate inclusion of the corresponding subset data with the existing header data. In an example, if the corresponding existing header data within a header of the one or more headers is pre-populated with some information, the instructions 1110 may cause the processor(s) 1102 to automatically modify the corresponding existing header data using the data merging techniques, without any user input. In another example, if the existing header data within the header of the one or more headers is pre-populated with some information, the instructions 1110 may cause the processor(s) 1102 to prompt a user to indicate a particular merging option from a plurality of merging options and modify the corresponding existing header data in accordance with the particular merging option indicated by the user. For instance, the user may choose to simply append the corresponding subset data without changing pre-populated information within the existing header data. In another instance, the user may choose to replace the pre-populated information within the existing header data with the corresponding subset data.

For modifying the existing header data within each of the one or more headers, the instructions 1110 may cause the processor(s) 1102 to modify the existing header data within each header of the one or more headers having a single semantically similar field in the investigation data to include the field data corresponding to the semantically similar field to generate the updated CAPA record. For example, first field data corresponding to the first field “summary” may be incorporated in the corresponding existing header data within the first header “CAPA implementation summary”. Further, second field data corresponding to the second field “objective” may be incorporated in the corresponding existing header data within the second header “explanation of problem”.

Further, for each header of the one or more headers having two or more semantically similar fields in the investigation data, the instructions 1110 may cause the processor(s) 1102 to generate an interactive query dialog to seek a user input for selecting fields from the two or more semantically similar fields and prioritizing the selected fields. For example, the user may select one or both of the third field “root cause type” and the fourth field “root cause” for modifying the existing header data. If the user selects both the third field “root cause type” and the fourth field “root cause”, the user may also prioritize the selected fields by providing a hierarchical arrangement of the third field and the fourth field. The instructions 1110 may further cause the processor(s) 1102 to receive a user input specifying the hierarchical arrangement of selected fields from the two or more semantically similar fields. The instructions 1110 may further cause the processor(s) 1102 to modify the existing header data within the header to include the field data corresponding to the selected fields in accordance with the hierarchical arrangement to generate the updated CAPA record. The updated CAPA record may thus be a version of the pre-existing CAPA record once each of the one or more headers are modified using the investigation data.

The instructions 1110 may then cause the processor(s) 1102 to link the updated CAPA record to the recall decision investigation. In an example, linking the updated CAPA record to the recall decision investigation may include transmitting the updated CAPA record to the quality management server 204 for updating CAPA records managed by the quality management server 204.

In an example, the instructions 1110 may cause the processor(s) 1102 to summarize the investigation data to generate a summarized investigation report. Further, the instructions 1110 may cause the processor(s) 1102 to attach the summarized investigation report within the updated CAPA record or the new CAPA record that is linked to the recall decision investigation. In an example, the summarized investigation report may be attached in different file formats, such as a portable document format (PDF) or an editable format. In an example, the summarized investigation report may be attached in a default file format, unless the user specifically provides inputs regarding the desired file format. In an example, the summarized investigation report may capture key findings, conclusions, and recommendations from the full investigation data.

For efficient semantical comparison, all historical investigation reports and historical CAPA records associated with the organization may be stored in vector databases in a vectorized form. In an example, the instructions 1110 may cause the processor(s) 1102 to obtain a plurality of investigation reports corresponding to each of a plurality of historical recall decision investigations conducted in the organization. In an example, the plurality of investigation reports may be obtained from the recall investigation server. In another example, the plurality of investigation reports may be pre-stored in the memory of the system 100 and may be obtained from the memory.

For each historical recall decision investigation of the plurality of historical recall decision investigations, the instructions 1110 may cause the processor(s) 1102 to analyze prior investigation data within the plurality of investigation reports corresponding to the historical recall decision investigation to generate vectorized prior investigation data. The instructions 1110 may then cause the processor(s) 1102 to store the vectorized prior investigation data associated with the plurality of historical recall decision investigations in a first vector database, say the first vector database 504, associated with an investigation platform utilized by the organization for conducting recall decision investigations. The investigation platform may be managed through the recall investigation server. Storing the vectorized prior investigation data in the first vector database allows the organization to maintain a searchable history of the plurality of historical recall decision investigations.

Further, the instructions 1110 may cause the processor(s) 1102 to analyze the CAPA data corresponding to each of the plurality of pre-existing CAPA records to generate vectorized CAPA data. The instructions 1110 may then cause the processor(s) 1102 to store the vectorized CAPA data associated with the plurality of pre-existing CAPA records in a second vector database, say the second vector database 506, associated with a quality management platform utilized by the organization to manage CAPA records of the organization. The quality management platform may be managed through the quality management server 204. Storing the vectorized CAPA data in the second vector database allows the organization to maintain a searchable history of the plurality of pre-existing CAPA records. In an example, a same vectorization model may be utilized for generating the vectorized prior investigation data and the vectorized CAPA data.

With respect to the recall decision investigation for which the CAPA configuration request is received, the instructions 1110 may cause the processor(s) 1102 to analyze the investigation data to generate vectorized investigation data. Then, the instructions 1110 may cause the processor(s) 1102 to query the first vector database to identify one or more investigation vectors, from the vectorized prior investigation data within the first vector database, which are similar to the vectorized investigation data. The instructions 1110 may then cause the processor(s) 1102 to obtain similar investigation reports, from the plurality of investigation reports of the plurality of historical recall decision investigations, associated with each of the one or more investigation vectors.

Further, the instructions 1110 may cause the processor(s) 1102 to query the second vector database to identify one or more CAPA vectors, from the vectorized CAPA data within the second vector database, which are similar to the vectorized investigation data. The instructions 1110 may then cause the processor(s) 1102 to obtain similar CAPA records, from the pre-existing CAPA records, associated with each of the one or more CAPA vectors. The instructions 1110 may then cause the processor(s) 1102 to attach at least one of the similar investigation reports and the similar CAPA records within the updated CAPA record or the new CAPA record that is linked to the recall decision investigation. By implementing automated semantic analysis and attaching similar investigation reports and the similar CAPA records within the new CAPA record or the updated CAPA record, the present subject matter ensures that similar issues are identified and addressed consistently across the organization, reducing variability in CAPA record creation and management. Thus, the present subject matter contributes to a more efficient, effective, and proactive approach to quality management, enabling organizations to maintain high standards of product quality and safety while optimizing use of manual or computational resources.

Although examples for the present disclosure have been described in language specific to structural features and/or methods, it is to be understood that the appended claims are not necessarily limited to the specific features or methods described. Rather, the specific features and methods are disclosed and explained as examples of the present disclosure.

We claim:

1. A system comprising:
a communication module to:
receive a corrective and preventive action (CAPA) configuration request corresponding to a recall decision investigation conducted in an organization;
a data acquisition engine to:
obtain one or more investigation reports having investigation data associated with the recall decision investigation; and
a CAPA generation engine to:
analyze the investigation data and CAPA data corresponding to each of a plurality of pre-existing CAPA records associated with the organization to identify a pre-existing CAPA record, from amongst the plurality of pre-existing CAPA records, that is semantically similar to at least a part of the investigation data;
analyze the investigation data and CAPA data corresponding to the pre-existing CAPA record to identify one or more headers within the pre-existing CAPA record for which semantically relatable data is present within the investigation data, wherein for each of the one or more headers, the investigation data includes semantically relatable corresponding subset data;
modify existing header data within each of the one or more headers to include the corresponding subset data from the investigation data to generate an updated CAPA record; and
link the updated CAPA record to the recall decision investigation.

2. The system of claim 1, wherein the investigation data comprises a plurality of fields and field data corresponding to each of the plurality of fields, and wherein, for each pre-existing CAPA record of the plurality of pre-existing CAPA records, the CAPA data comprises a plurality of headers within the pre-existing CAPA record and existing header data present within each of the plurality of headers, and wherein to analyze the investigation data and the CAPA data corresponding to the pre-existing CAPA record, the CAPA generation engine is to:
semantically compare the plurality of fields with the plurality of headers corresponding to the pre-existing CAPA record to identify semantically similar fields and headers, wherein each header identified to have at least one semantically similar field in the investigation data is designated as the one or more headers for which semantically relatable data is present within the investigation data.

3. The system of claim 2, wherein to modify the existing header data within each of the one or more headers, the CAPA generation engine is to:
for each header of the one or more headers having a single semantically similar field in the investigation data, modify the existing header data within the header to include the field data corresponding to the semantically similar field to generate the updated CAPA record; and
for each header of the one or more headers having two or more semantically similar fields in the investigation data:
generate an interactive query dialog seeking a user input for selecting fields from the two or more semantically similar fields and prioritizing the selected fields;
receive a user input specifying a hierarchical arrangement of selected fields from the two or more semantically similar fields; and
modify the existing header data within the header to include the field data corresponding to the selected fields in accordance with the hierarchical arrangement to generate the updated CAPA record.

4. The system of claim 1, wherein the CAPA generation engine is to:
summarize the investigation data to generate a summarized investigation report; and
attach the summarized investigation report within the updated CAPA record linked to the recall decision investigation.

5. The system of claim 1, wherein the system comprises a data processing engine to:
obtain a plurality of investigation reports corresponding to each of a plurality of historical recall decision investigations;
for each historical recall decision investigation of the plurality of historical recall decision investigations, analyze prior investigation data within the plurality of investigation reports corresponding to the historical recall decision investigation to generate vectorized prior investigation data;
store the vectorized prior investigation data associated with the plurality of historical recall decision investigations in a first vector database associated with an investigation platform utilized by the organization for conducting recall decision investigations;
analyze the CAPA data corresponding to each of the plurality of pre-existing CAPA records to generate vectorized CAPA data; and
store the vectorized CAPA data associated with the plurality of pre-existing CAPA records in a second vector database associated with a quality management platform utilized by the organization.

6. The system of claim 5, wherein the CAPA generation engine is to:
analyze the investigation data to generate vectorized investigation data;
query the first vector database to identify one or more investigation vectors, from the vectorized prior investigation data within the first vector database, which are similar to the vectorized investigation data;
obtain similar investigation reports, from the plurality of investigation reports of the plurality of historical recall decision investigations, associated with each of the one or more investigation vectors;
query the second vector database to identify one or more CAPA vectors, from the vectorized CAPA data within the second vector database, which are similar to the vectorized investigation data;
obtain similar CAPA records, from the pre-existing CAPA records, associated with each of the one or more CAPA vectors; and
attach at least one of the similar investigation reports and the similar CAPA records within the updated CAPA record linked to the recall decision investigation.

7. A method comprising:
receiving a corrective and preventive action (CAPA) configuration request corresponding to a recall decision investigation conducted in an organization;
obtaining one or more investigation reports having investigation data associated with the recall decision investigation; and
analyzing the investigation data and CAPA data corresponding to each of a plurality of pre-existing CAPA records associated with the organization to ascertain whether any pre-existing CAPA record, from amongst the plurality of pre-existing CAPA records, is semantically similar to at least a part of the investigation data;
upon ascertaining a pre-existing CAPA record, from the plurality of pre-existing CAPA records, to be semantically similar to at least a part of the investigation data:
updating the pre-existing CAPA record by incorporating at least a subset of the investigation data to generate an updated CAPA record; and
linking the updated CAPA record to the recall decision investigation; and
upon ascertaining that no pre-existing CAPA record is semantically similar to at least a part of the investigation data:
creating a new CAPA record by incorporating at least a subset of the investigation data; and
linking the new CAPA record to the recall decision investigation.

8. The method of claim 7, wherein updating the pre-existing CAPA record comprises:
analyzing the investigation data and CAPA data corresponding to the pre-existing CAPA record to identify one or more headers within the pre-existing CAPA record for which semantically relatable data is present within the investigation data, wherein for each of the one or more headers, the investigation data includes semantically relatable corresponding subset data; and
modifying existing header data within each of the one or more headers to include the corresponding subset data from the investigation data to generate the updated CAPA record.

9. The method of claim 7, wherein creating the new CAPA record comprises:
obtaining a pre-defined CAPA format associated with the organization, the pre-defined CAPA format comprising a set of headers;
analyzing the investigation data and the set of headers to identify at least one header, from amongst the set of headers, for which semantically relatable data is present within the investigation data, wherein for each of the at least one header, the investigation data includes semantically relatable corresponding subset data; and
updating header data within each of the at least one header to include the corresponding subset data from the investigation data to generate the new CAPA record.

10. The method of claim 7, wherein the investigation data comprises a plurality of fields and field data corresponding to each of the plurality of fields, and wherein creating the new CAPA record comprises:
obtaining a pre-defined CAPA format associated with the organization, the pre-defined CAPA format comprising a set of headers;
semantically comparing the plurality of fields with the set of headers to identify semantically similar fields and headers;
for each header of the set of headers having a single semantically similar field in the investigation data, updating header data within the header to include the field data corresponding to the semantically similar field to generate the new CAPA record; and
for each header of the set of headers having two or more semantically similar fields in the investigation data:
generating an interactive query dialog seeking a user input for selecting fields from the two or more semantically similar fields and prioritizing the selected fields;
receiving a user input specifying a hierarchical arrangement of selected fields from the two or more semantically similar fields; and
updating header data within the header to include the field data corresponding to the selected fields in accordance with the hierarchical arrangement to generate the new CAPA record.

11. The method of claim 7, wherein the investigation data comprises a plurality of fields and field data corresponding to each of the plurality of fields, and wherein, for each pre-existing CAPA record of the plurality of pre-existing CAPA records, the CAPA data comprises a plurality of headers within the pre-existing CAPA record and existing header data present within each of the plurality of headers.

12. The method of claim 11, wherein updating the pre-existing CAPA record comprises:
semantically comparing the plurality of fields with the plurality of headers corresponding to the pre-existing CAPA record to identify semantically similar fields and headers;
for each header of the plurality of the headers having a single semantically similar field in the investigation data, modifying the existing header data within the header to include the field data corresponding to the semantically similar field to generate the updated CAPA record; and
for each header of the plurality of the headers having two or more semantically similar fields in the investigation data:
generating an interactive query dialog seeking a user input for selecting fields from the two or more semantically similar fields and prioritizing the selected fields;
receiving a user input specifying a hierarchical arrangement of selected fields from the two or more semantically similar fields; and
modifying the existing header data within the header to include the field data corresponding to the selected fields in accordance with the hierarchical arrangement to generate the updated CAPA record.

13. The method of claim 7, wherein the method comprises:
summarizing the investigation data to generate a summarized investigation report; and
attaching the summarized investigation report within the updated CAPA record or the new CAPA record that is linked to the recall decision investigation.

14. The method of claim 7, wherein the method comprises:
obtaining a plurality of investigation reports corresponding to each of a plurality of historical recall decision investigations;
for each historical recall decision investigation of the plurality of historical recall decision investigations, analyzing prior investigation data within the plurality of investigation reports corresponding to the historical recall decision investigation to generate vectorized prior investigation data;
storing the vectorized prior investigation data associated with the plurality of historical recall decision investigations in a first vector database associated with an investigation platform utilized by the organization for conducting recall decision investigations;
analyzing the CAPA data corresponding to each of the plurality of pre-existing CAPA records to generate vectorized CAPA data; and
storing the vectorized CAPA data associated with the plurality of pre-existing CAPA records in a second vector database associated with a quality management platform utilized by the organization.

15. The method of claim 14, wherein the method comprises:
analyzing the investigation data to generate vectorized investigation data;
querying the first vector database to identify one or more investigation vectors, from the vectorized prior investigation data within the first vector database, which are similar to the vectorized investigation data;
obtaining similar investigation reports, from the plurality of investigation reports of the plurality of historical recall decision investigations, associated with each of the one or more investigation vectors;
querying the second vector database to identify one or more CAPA vectors, from the vectorized CAPA data within the second vector database, which are similar to the vectorized investigation data;
obtaining similar CAPA records, from the pre-existing CAPA records, associated with each of the one or more CAPA vectors; and
attaching at least one of the similar investigation reports and the similar CAPA records within the updated CAPA record or the new CAPA record that is linked to the recall decision investigation.

16. A non-transitory computer-readable medium comprising instructions for configuring a corrective and preventive action (CAPA) record corresponding to a recall decision investigation, the instructions being executable by a processing resource to:
receive a corrective and preventive action (CAPA) configuration request corresponding to a recall decision investigation conducted in an organization;
obtain one or more investigation reports having investigation data associated with the recall decision investigation;
obtain a pre-defined CAPA format associated with the organization, the pre-defined CAPA format comprising a set of headers;
analyze the investigation data and the set of headers to identify at least one header, from amongst the set of headers, for which semantically relatable data is present within the investigation data, wherein for each of the at least one header, the investigation data includes semantically relatable corresponding subset data;
update header data within each of the at least one header to include the corresponding subset data from the investigation data to generate a new CAPA record; and
link the new CAPA record to the recall decision investigation.

17. The non-transitory computer-readable medium of claim 16, wherein the investigation data comprises a plurality of fields and field data corresponding to each of the plurality of fields, and wherein to analyze the investigation data and the set of headers, the instructions are executable by the processing resource to:
semantically compare the plurality of fields with the set of headers to identify semantically similar fields and headers, wherein each header identified to have at least one semantically similar field in the investigation data is designated as the at least one header for which semantically relatable data is present within the investigation data.

18. The non-transitory computer-readable medium of claim 17, wherein to update the header data within each of the at least one header, the instructions are executable by the processing resource to:
for each header of the at least one header having one semantically similar field in the investigation data, update the header data within the header to include the field data corresponding to the semantically similar field to generate the new CAPA record; and
for each header of the at least one header having two or more semantically similar fields in the investigation data:
generate an interactive query dialog seeking a user input for selecting fields from the two or more semantically similar fields and prioritizing the selected fields;
receive a user input specifying a hierarchical arrangement of selected fields from the two or more semantically similar fields; and
update the header data within the header to include the field data corresponding to the selected fields in accordance with the hierarchical arrangement to generate the new CAPA record.

19. The non-transitory computer-readable medium of claim 16, wherein the instructions are executable by the processing resource to:
obtain a plurality of investigation reports corresponding to each of a plurality of historical recall decision investigations;
for each historical recall decision investigation of the plurality of historical recall decision investigations, analyze prior investigation data within the plurality of investigation reports corresponding to the historical recall decision investigation to generate vectorized prior investigation data;
store the vectorized prior investigation data associated with the plurality of historical recall decision investigations in a first vector database associated with an investigation platform utilized by the organization for conducting recall decision investigations;
obtain a plurality of pre-existing CAPA records associated with the organization;
analyze CAPA data corresponding to each of the plurality of pre-existing CAPA records to generate vectorized CAPA data; and
store the vectorized CAPA data associated with the plurality of pre-existing CAPA records in a second vector database associated with a quality management platform utilized by the organization.

20. The non-transitory computer-readable medium of claim 19, wherein the instructions are executable by the processing resource to:
analyze the investigation data to generate vectorized investigation data;
query the first vector database to identify one or more investigation vectors, from the vectorized prior investigation data within the first vector database, which are similar to the vectorized investigation data;
obtain similar investigation reports, from the plurality of investigation reports of the plurality of historical recall decision investigations, associated with each of the one or more investigation vectors;
query the second vector database to identify one or more CAPA vectors, from the vectorized CAPA data within the second vector database, which are similar to the vectorized investigation data;
obtain similar CAPA records, from the pre-existing CAPA records, associated with each of the one or more CAPA vectors; and
attach at least one of the similar investigation reports and the similar CAPA records within the new CAPA record that is linked to the recall decision investigation.
